(19) United States
(12) Patent Application Publication
(10) Pub. No.: US 2019/0318417 A1
(43) Pub. Date: Oct. 17, 2019

(54) METHOD AND SYSTEM ASSOCIATED WITH A SMART SHOPPING APPARATUS

(71) Applicant: MrG Systems, LLC., Phoenix, CA (US)

(72) Inventors: Wilfredo C. Gumaru, Phoenix, AZ (US); Wilfredo Kristoffer Gumaru, Phoenix, AZ (US)

(21) Appl. No.: 16/382,902

(22) Filed: Apr. 12, 2019

Related U.S. Application Data
(60) Provisional application No. 62/656,963, filed on Apr. 12, 2018.

(51) Int. Cl. G06Q 30/06; G06K 7/14

(52) U.S. Cl. CPC G06Q 30/0635; G06K 7/1413

(57) ABSTRACT

Embodiments of a method and/or system can include detecting placement of one or more items in relation to a smart shopping apparatus; collecting sensor data describing one or more item identifiers of the one or more items, where the sensor data corresponds to one or more sensors of the smart shopping apparatus; identifying one or more item profiles describing the one or more items, based on the sensor data; determining one or more shopping parameters associated with the shopping period, based on the one or more item profiles; and facilitating a purchase transaction for the one or more items based on one or more of the shopping parameters.

### CROSS-REFERENCE TO RELATED APPLICATIONS

This application claims the benefit of U.S. Provisional Application Ser. No. 62/656,963, filed on 12 Apr. 2018, which is herein incorporated in its entirety by this reference.

### TECHNICAL FIELD

This disclosure generally relates to the field of shopping apparatuses.

### BRIEF DESCRIPTION OF THE FIGURES

FIG. 1 includes a flowchart representation of variations of an embodiment of a method;

FIG. 2 includes a flowchart representation of variations of an embodiment of a method;

FIG. 3 includes a representation of variations of an embodiment of a method;

FIG. 4 includes a representation of variations of an embodiment of a system;

FIG. 5 includes a representation of variations of collecting sensor data and identifying an item profile;

FIG. 6 includes a representation of variations of applying security processes;

FIG. 7 includes a specific example of applying a security process;

FIG. 8 includes a specific example of facilitating a purchase transaction;

FIG. 9 includes a specific example of routing a user; and

FIG. 10 includes a specific example of facilitating a remote purchase transaction.

### DESCRIPTION OF THE EMBODIMENTS

The following description of the embodiments is not intended to be limited to these embodiments, but rather to enable any person skilled in the art to make and use.

### 1. Overview

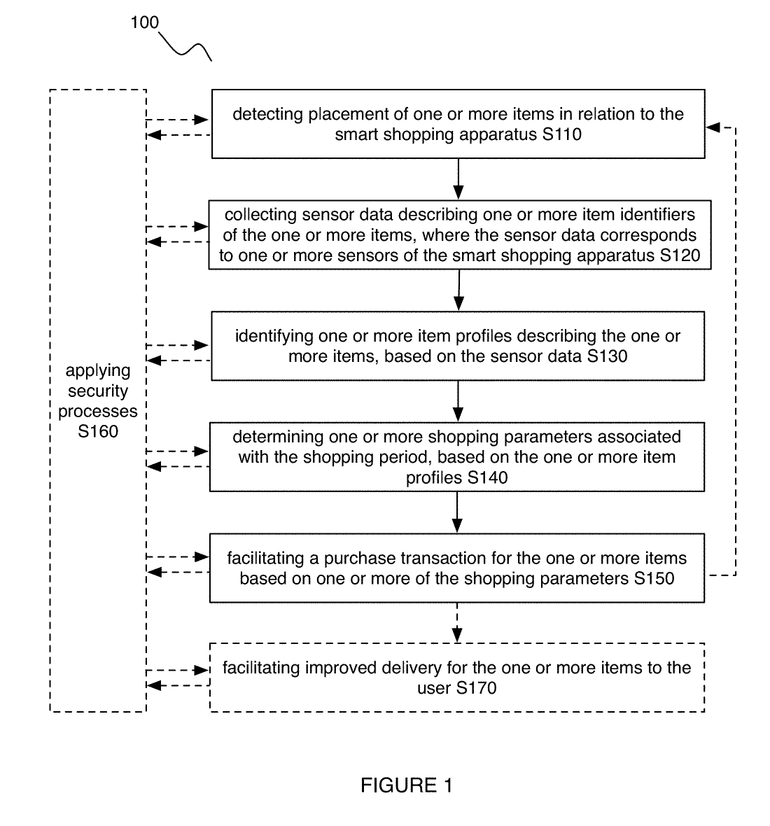

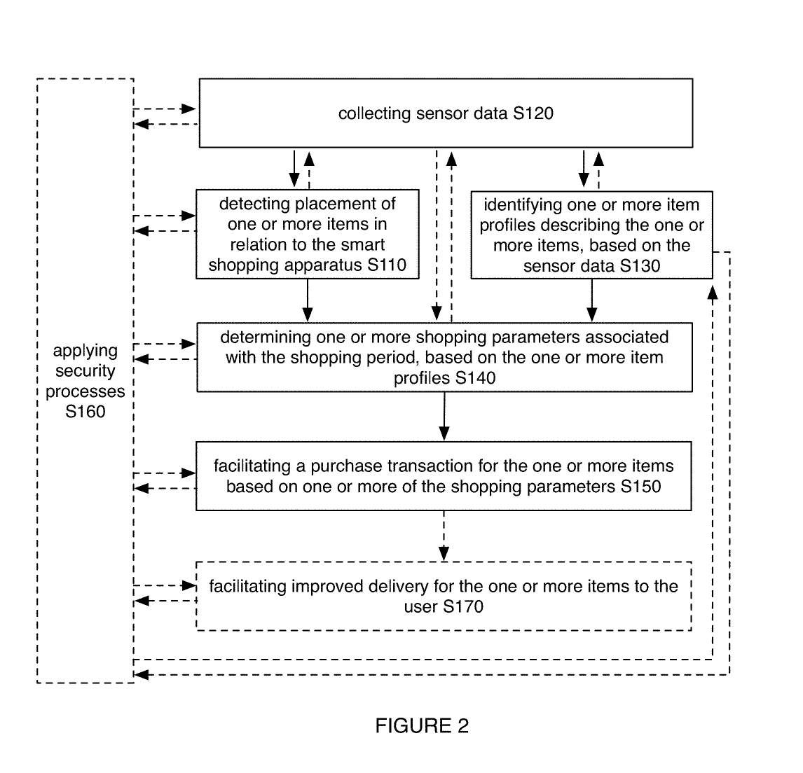

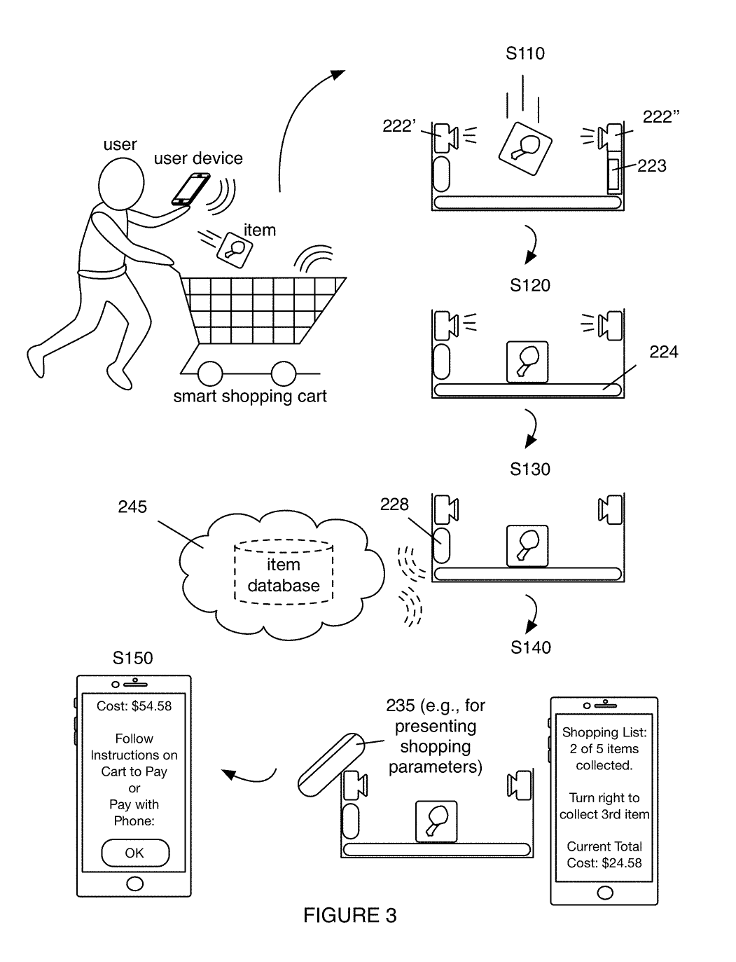

As shown in FIGS. 1-3, embodiments of a method 100 for applying a smart shopping apparatus (e.g., a smart shopping cart; smart shopping basket; smart shopping bag; etc.) to improve a shopping period for a user in relation to one or more items can include: detecting placement of the one or more items in relation to (e.g., into, out of, within, etc.) the smart shopping apparatus (e.g., based on first sensor data) Silo; collecting sensor data (e.g., second sensor data) describing one or more item identifiers of the one or more items, where the sensor data corresponds to one or more sensors of the smart shopping apparatus S120; identifying one or more item profiles describing the one or more items, based on the sensor data (e.g., based on the second sensor data and/or the first sensor data) S130; determining one or more shopping parameters associated with the shopping period, based on the one or more item profiles S140; and facilitating a purchase transaction for the one or more items based on one or more of the shopping parameters S150. Additionally or alternatively, embodiments of the method 100 can include: applying security processes (e.g., for hindering item theft, for hindering tampering of the smart shopping apparatus, etc.) S160; facilitating improved delivery for the one or more items to the user S170; and/or any other suitable processes.

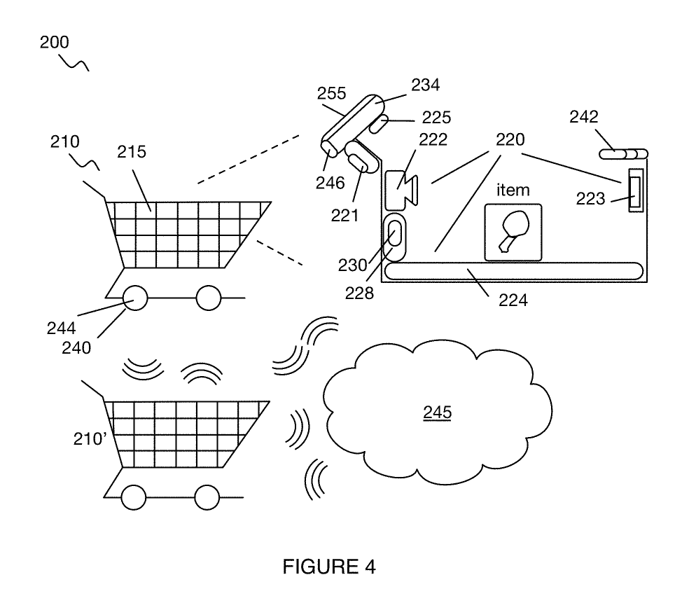

As shown in FIG. 4, embodiments of the system 200 can include one or more smart shopping apparatuses 210 (e.g., a single smart shopping apparatus; a second smart shopping apparatus 210′, a fleet of smart shopping apparatuses; etc.), where each smart shopping apparatus 210 can include one or more of an item compartment 215, a sensor set 220, a shopping apparatus processing system 228, a communication system 230, a user interface 235, mechanical components 240 (e.g., wheels 244, lids 242, etc.), a power system, and/or other suitable components. Additionally or alternatively, the system 200 can include a remote computing system 245, a docking station 250, a point of sale system 255 (e.g., for facilitating purchase transactions, etc.), applications (e.g., web applications; mobile device applications; applications for facilitating purchase transactions; applications for facilitating communications with smart shopping apparatuses, remote computing systems, and/or other suitable components; an application programming interface for accessing, modifying and/or retrieving data herein; etc.), and/or any other suitable components.

In variations, smart shopping apparatuses can include any one or more of smart shopping carts (e.g., smart push carts with one or more push handles, etc.), smart shopping baskets (e.g., smart hand-held carry baskets, etc.), smart shopping trolleys, smart shopping bags, and/or any suitable type of smart shopping apparatus, such as including any suitable type of form for facilitating one or more shopping periods for one or more users.

Embodiments of the method 100 and/or the system 200 can function to improve shopping experiences for users (e.g., users of the smart shopping apparatus; customers at merchant stores; etc.), such as during shopping periods at merchant stores. In examples, embodiments can enable increased convenience (e.g., checkout without cashiers; decreased time waiting in shopping lines; routing guidance for finding items of interest; financial guidance such as real-time updating of estimated cost of items in the smart shopping apparatus; etc.), personalization (e.g., targeted notifications such as advertisements; personalized shopping list fulfillment; etc.), privacy (e.g., tracking of items in the smart shopping apparatus rather than personal user data; providing options to users in relation to smart shopping apparatus usage and/or associated data collection; etc.), and/or other suitable aspects. Embodiments can additionally or alternatively function to improve merchant operation, such as in relation to security (e.g., hindering theft; hindering tampering with merchant systems such as checkout devices; etc.), analytics (e.g., shopping analytics metrics describing user behavior in relation to their experiences at merchant stores; etc.), inventory management (e.g., real-time inventory updates; improved accuracy; improved forecasting based on shopping analytics metrics; etc.), technology integration (e.g., integrating smart shopping apparatus operation with existing merchant systems and/or infrastructure; etc.), employee management (e.g., leveraging the smart shopping apparatus technology to handle the traditional responsibilities of cashiers and baggers; etc.) and/or any other suitable aspects. As such, in specific examples, the technology can provide technical solutions necessarily rooted in computer technology such as to overcome issues specifically arising with computer technology. However, embodiments of the method 100 and/or system 200 can include any suitable functionality.

Additionally or alternatively, data described herein (e.g., sensor data, item profiles, item identifiers, shopping parameters, contextual shopping-related data, notifications, etc.) can be associated with any suitable temporal indicators (e.g., seconds, minutes, hours, days, weeks, etc.) including one or more: temporal indicators indicating when the data was collected, determined, transmitted, received, and/or otherwise processed (e.g., temporal indicators indicating a purchase time for items in a smart shopping apparatus; temporal indicators associated with enabling or disabling of security processes; etc.); temporal indicators providing context to content described by the data, such as temporal indicators indicating the time at which one or more items was placed or removed from a smart shopping apparatus (e.g., time of placement of items by a user in relation to the smart shopping apparatus; time of placement of items by a merchant entity into a smart shopping apparatus for fulfillment of a remote purchase transaction; etc.); changes in temporal indicators (e.g., data over time; change in data; data patterns; data trends; data extrapolation and/or other prediction; shopping analytics metrics over time; etc.); and/or any other suitable indicators related to time.

Additionally or alternatively, parameters, metrics, inputs, outputs, and/or other suitable data can be associated with value types including: scores (e.g., similarity scores between stored item profiles and sensor data indicating characteristics of a current item in the smart shopping apparatus, for identifying items; etc.), binary values, classifications (e.g., item classifications for item profiles; etc.), confidence levels, values along a spectrum, and/or any other suitable types of values. Any suitable types of data described herein can be used as inputs (e.g., for different models described herein; for portions of embodiments of the method 100; etc.), generated as outputs (e.g., of models), and/or manipulated in any suitable manner for any suitable components associated with embodiments of the method 100 and/or system 200.

One or more instances and/or portions of embodiments of the method 100 and/or processes described herein can be performed asynchronously (e.g., sequentially), concurrently (e.g., in parallel; concurrently on different threads for parallel computing to improve system processing ability for item identification, shopping parameter determination, and/or other suitable functionality; etc.), in temporal relation to a trigger condition (e.g., performance of a portion of the method 100), and/or in any other suitable order at any suitable time and frequency by and/or using one or more instances of embodiments of the system 200, components, and/or entities described herein.

However, the method 100 and/or system 200 can be configured in any suitable manner.

### 2. Examples

In examples, the method 100 and/or system 200 can confer at least several improvements over conventional approaches. Specific examples of the method 100 and/or system 200 can confer technologically-rooted solutions to at least challenges described herein.

In specific examples, the technology can transform entities (e.g., smart shopping apparatuses; users; merchant stores; merchant entities; items, etc.) into different states or things. For example, physical components (e.g., mechanical components, etc.) of a smart shopping apparatus can be transformed (e.g., manipulated, modified, caused to be transformed, etc.), such as the closing and/or opening of a lid for covering an item compartment; the locking and/or other movement hindrance of one or more wheels of the smart shopping apparatus; audio emission by speakers of the smart shopping apparatus; presentation of notifications at a user interface of the smart shopping apparatus; and/or other suitable transformations. In a specific example, a component of a smart shopping apparatus can be transformed in response to a trigger condition (e.g., closing of a lid in response to purchase transaction completion; opening of a lid in response to detection of the user and/or smart shopping apparatus at a bagging area and/or area for transfer of items to a user; trigger conditions enabling and/or disabling of one or more security processes; etc.).

In specific examples, the technology can leverage specialized computing-related devices (e.g., smart shopping apparatuses including sensors, shopping apparatus processing systems, communication systems, user interfaces, etc.) in obtaining, analyzing, and/or otherwise processing item-related data (e.g., sensor data capturing item identifier of one or more items placed into a smart shopping apparatus; etc.) for facilitating item identification and/or shopping parameter determination.

In specific examples, the technology can include an inventive distribution of functionality across a network including one or more smart shopping apparatuses, remote computing systems, remote merchant processing systems, user devices, and/or any other suitable components. For example, smart shopping apparatuses can collect sensor data on items associated with a shopping period for use in item identification and shopping parameter determination by the one or more smart shopping apparatuses and/or remote computing systems, while maintaining updated item inventories for merchant stores through integration with and communication with remote merchant processing systems. In a specific example, personalized, tailored shopping parameters (e.g., determined based on item profile identification for items associated with a shopping period; etc.) can be delivered (e.g., transmitted, presented, etc.) to a user, such as at a user device (e.g., through an application executing on the user device; at a user device receiving communications from the smart shopping apparatus and/or remote computing system; etc.), a user interface of the smart shopping apparatus, and/or at any suitable components.

In specific examples, the technology can confer improvements in the technical fields of at least artificial intelligence, computer vision, physical item identification and modeling, sensor technology, and/or other relevant fields.

However, in specific examples, the technology can provide any other suitable improvements, such as in the context of using non-generalized processing systems and/or other suitable components; in the context of performing suitable portions of embodiments of the method 100; and/or in the context of applying suitable components of embodiments of the system 200.

### 3.1 Detecting Item Placement.

Embodiments of the method 100 can include detecting placement of one or more items in relation to a smart shopping apparatus Silo, which can function to determine an event associated with item placement into, within, out of, and/or otherwise in relation to the smart shopping apparatus, such as for facilitating (e.g., triggering, providing inputs for, etc.) downstream processing (e.g., item identification, shopping parameter determination, etc.) associated with the one or more items.

Detecting placement of items into (and/or out of, within, etc.) a smart shopping apparatus is preferably based on collected sensor data corresponding to one or more sensors of the smart shopping apparatus. As such, detecting placement of items in relation to a smart shopping apparatus can be based on any one or more of: optical sensor data (e.g., data from image sensors; data from light sensors; data indicating placement of item in relation to the smart shopping apparatus, such as based on a temporary blockage of the field of view of the optical sensor, such as based on detection of an item identifier within a threshold distance of the optical sensor; etc.), weight sensor data (e.g., based on changes in weight detected by a scale weighing the items placed into or taken out of the smart shopping apparatus; etc.), audio sensors (e.g., based on audio generated from the placement of items in relation to the smart shopping apparatus; etc.), temperature sensor data (e.g., for detecting change in temperature influenced by types of items placed in the smart shopping apparatus, such as items at temperatures differing from that of the smart shopping apparatus; etc.), location sensor data (e.g., ultra-wideband data; beacon data; higher probability of an item being placed in a smart shopping apparatus based on a closer proximity of the smart shopping apparatus to one or more items; comparing location sensor data to historic location sensor data for historic shopping periods of the same user, different users, and/or other suitable entities, where statistical insights regarding the probability of item placement in relation to the smart shopping apparatus can be derived based on the comparisons of location sensor data; etc.), proximity sensor data (e.g., electromagnetic sensor data, capacitive sensor data, ultrasonic sensor data, light detection and ranging, light amplification for detection and ranging, line laser scanner, laser detection and ranging, etc.), volatile compound sensor data, humidity sensor data, depth sensor data, motion sensor data (e.g., for detecting motion of one or more smart shopping apparatuses before, during, or after placement of items in relation to the smart shopping apparatuses; for detecting motion of a user in association with item placement in relation to a smart shopping apparatus, such as detecting a user arm motion as a user physically obtains and item and places the item in relation to a smart shopping apparatus; etc.), biometric sensor data, pressure sensor data, flow sensor data, power sensor data, and/or or any other suitable sensor data corresponding to any suitable types of sensors.

In a specific example, optical data from a plurality of optical sensors (e.g., two or more cameras) can be used in determining placement of items in relation to a smart shopping apparatus (e.g., images, associated with overlapping temporal indicators, indicating the item being placed in relation to the smart shopping apparatus; images from two optical sensors placed on opposite interior faces of the smart shopping apparatus and/or the item compartment of the smart shopping apparatus, with fields of view including the other optical sensor; etc.). In a specific example, detecting item placement can include analyzing a set of images (e.g., a video, etc.) representing motion of an item into, within, and/or out of an item compartment of a smart shopping apparatus, where analyzing the set of images can include analyzing directionality, proximity, type of, position, velocity, acceleration, orientation, and/or suitable physical aspects of one or more items such as in relation to a corresponding smart shopping apparatus. In a specific example, optical data can be collected from a plurality of cameras positioned at predetermined locations of a smart shopping apparatus and/or at predetermined orientations for enabling a field of view adapted for detecting items placed in relation to (e.g., proximal to) the smart shopping apparatus. In a specific example, detecting placement of items in relation to a smart shopping apparatus can be based on proximity sensor data and/or directional sensor data, such as for detecting proximity of one or more items proximal the smart shopping apparatus, without physical contact between the one or more items and a proximity sensor and/or directional sensor.

In variations, determinations of item placement in relation to a smart shopping apparatus can be verified by different types of sensor data and/or by any suitable data. For example, the method 100 can include determining, with a confidence level, item placement into a smart shopping apparatus based on first sensor data (e.g., optical sensor data); and verifying (e.g., in response to the confidence level below a threshold) the determination of the item placement based on second sensor data (e.g., proximity sensor data, weight sensor data, etc.), such as where verifying can include updating the confidence level (e.g., based on analysis of the second sensor data, etc.).

In examples, collected sensor data can be used in placement detection models (e.g., artificial intelligence models trained on data associated with item placement into smart shopping apparatuses, item removal from smart shopping apparatuses, and/or the lack of an item placement or removal event; models employing any suitable algorithms or approaches described herein; etc.) for detecting placement of the one or more items in relation to one or more smart shopping apparatuses. In an example, placement detection models can include neural network models (e.g., convolutional neural networks) and/or other suitable artificial intelligence models, such as where collected sensor data (and/or features extracted from the collected sensor data) can be used as inputs in the placement detection models (e.g., as inputs for the input neural layer of a neural network model, etc.).

Additionally or alternatively detecting placement of items in relation to a smart shopping apparatus can be based on one or more of: user inputs (e.g., a user manually touching a touch-screen provided option for indicating that one or more new items have been placed in the smart shopping apparatus, such as where the option can be provided through the apparatus user interface, a user device, an application, etc.; a user verbally indicating the item placement in relation to the shopping apparatus; etc.), contextual shopping-related data (e.g., indicating user shopping behavior to inform probabilities of a user purchasing specific items, which can be used to inform whether such items were placed in the smart shopping apparatus; etc.), other sensor data (e.g., sensor data corresponding to sensors of a user device, etc.) and/or any other suitable data.

Detecting item placement can be for items placed by users (e.g., users holding the smart shopping apparatus, users operating the smart shopping apparatus, users proximal to the smart shopping apparatus; etc.), mechanical devices (e.g., robotic item displacers, drones, mechanical item displacers; etc.), merchant entities (e.g., merchant employees, item pickers, item fulfillment aids, etc.), and/or any other suitable entities. Detecting placement of items in relation to a smart shopping apparatus is preferably performed by a shopping apparatus processing system (e.g., based on the collected sensor data) of the smart shopping apparatus, but can additionally or alternatively be performed by any suitable component (e.g., remote computing system, user device such as a mobile computing device, etc.).

Detection of items placed in a smart shopping apparatus is preferably performed in real-time. In an example, detected changes in sensor data (e.g., beyond a threshold; a change in weight values detected by the scale beyond a threshold; etc.) can trigger evaluation by a processing system (e.g., shopping apparatus processing system, etc.) in relation to whether an item has been placed in relation to (e.g., into, out of, within, etc.) the smart shopping apparatus.

Additionally or alternatively, detection of items placed in a smart shopping apparatus can be performed at any suitable time in relation to the actual placement of the item in relation to the smart shopping apparatus (e.g., after a number of items has been placed in relation to the apparatus; after an amount of time has passed; after a weight threshold condition is reached; etc.), and/or at any suitable time and frequency.

In a variation, the method 100 can include detecting the removal of one or more items from the smart shopping apparatus, such as in an analogous manner to the approaches described herein (e.g., in real-time, removal by any suitable entity, removal based on any suitable detection algorithms and/or approaches; etc.) and/or based on any of the data described herein. For example, detecting removal of an item can be based on optical data (e.g., from one or more cameras of the smart shopping apparatus) indicating an item being removed (e.g., movement of an item upwards out of the shopping apparatus; a hand reaching in relation to the smart shopping apparatus to grab an item; etc.). In another example, item removal detection can be based on weight data (e.g., a negative change in weight detected by the scale, such as beyond a threshold change amount or in an amount equivalent to and/or similar to an item detected and identified as residing in the smart shopping cat; etc.).

However, detecting the placement of items in relation to a smart shopping apparatus Silo can be performed in any suitable manner.

### 3.2 Collecting Sensor Data.

Embodiments of the method 100 can include collecting sensor data S120, such as sensor describing one or more item identifiers of the one or more items, such as where the sensor data corresponds to one or more sensors of the smart shopping apparatus. Collecting sensor data can function to collect identifying information informative of the type of item placed into, removed from, and/or otherwise placed in relation to the smart shopping apparatus; collect data indicative of placement of one or more items in relation to the smart shopping apparatus; and/or collect sensor data suitable for use in any suitable portions of embodiments of the method 100.

Item identifiers can include any one or more of barcode values (e.g., a universal product code (UPC); a store product code such as merchant-determined product codes; GCID; EAN; JAN; ISBN; etc.), media associated with the item (e.g., images of the item, video of the item, marketing-related materials for the item, etc.), item characteristics (e.g., price; item category such as product category; physical item characteristics such as dimensions, weight, shape, form factor, color, texture, materials, and/or other physical characteristics; related items; visually similar items; brand; quantity; manufacturer; seller, etc.), merchant information (e.g., merchant identifiers, type of merchant, items sold by the merchant, etc.), a product description (e.g., a written description, abbreviated descriptions, merchant-determined product descriptions, etc.), and/or any other suitable information usable in identifying one or more items.

Collected sensor data is preferably mappable to one or more item identifiers, which are preferably mappable to one or more item profiles (e.g., one or more reference components of the one or more item profiles; etc.). However, collected sensor data can be associated with item identifiers and/or item profiles in any suitable manner.

Collecting sensor data associated with one or more item identifiers can include collecting sensor data including any one or more of: optical sensor data (e.g., of the item's packaging; of the UPC and/or store product code on the item; of the item's contents; of the item as a whole; of portions of the item; as the item is being placed into and/or removed from the smart shopping apparatus; as the item is residing in the smart shopping apparatus, such as at different time points; images; video; etc.); weight sensor data (e.g., weights of individual items placed into the smart shopping apparatus; etc.), audio sensors (e.g., audio generated from items placed into the smart shopping apparatus; etc.), temperature sensor data (e.g., for detecting temperature of items to indicate temperature characteristics of the item; etc.), location sensor data (e.g., extracting item identifier data based on the location of the item in the merchant store prior to being placed in the smart shopping apparatus; etc.), volatile compound sensor data, humidity sensor data, depth sensor data, inertial sensor data, biometric sensor data, pressure sensor data, flow sensor data, power sensor data, and/or or any other suitable sensor data corresponding to any suitable types of sensors.

In an example, collected sensor data can include barcode data collected by an optical sensor (e.g., barcode scanner; sensor that recognizes a universal product code, store product code, and/or other suitable barcode associated with an item). In another example, collected sensor data can include optical data from a plurality of optical sensors (e.g., two or more cameras). In a specific example, the method 100 can include using optical data from at least one of the plurality of optical sensors for identifying the presence of the barcode and/or other suitable aspects of the barcode (e.g., location, outline, characters associated with the barcode, etc.), extracting associated item identifier data (e.g., extracting the barcode values, such as the UPC code values, based on character recognition algorithms performed for the collected images of the items, etc.).

The sensor data can be overlapping with, the same as, independent from, and/or have any suitable association with sensor data used in detecting placement of items into the smart shopping apparatus, and/or sensor data used in any suitable portions of embodiments of the method 100. However, collected sensor data can be used for any number and types of functionality described herein.

Additionally or alternatively, item data collected for items associated with the smart shopping apparatus can additionally or alternatively include (e.g., additional or alternative to collected sensor data, etc.) any one or more of: user inputs (e.g., a user input for marking shopping list items as collected; user inputs in relation to notifications presented to the user, such as in relation to requesting guidance to particular items, in relation to interactions with advertisements, etc.), contextual shopping-related data (e.g., historic user shopping behavior to inform probable characteristics of items placed into the smart shopping apparatus; etc.), and/or any other suitable data.

Collected sensor data preferably corresponds to sensors of the smart shopping apparatus, but can additionally or alternatively correspond to (e.g., be sampled by, be collected by, etc.) one or more of user device sensors (e.g., mobile computing device sensors proximal to the items, etc.), merchant store sensors (e.g., sensors located within and/or proximal the merchant store in which the user is located; etc.), other smart shopping apparatus sensors (e.g., sensors of a second smart shopping apparatus operated by a second user proximal the first user; etc.), and/or sensors associated with any suitable entity and/or component.

Collecting sensor data describing with one or more item identifiers is preferably performed in real-time (e.g., in response to detecting item placement into and/or removal from the smart shopping apparatus; as the item is being placed into and/or removed from the shopping apparatus, such as where the collected sensor data overlaps with sensor data used in detecting item placement into and/or removal from the smart shopping apparatus; etc.), but can additionally or alternatively be performed at any suitable time (e.g., after the items have been placed into the smart shopping apparatus; as the items are residing in the smart shopping apparatus; at any suitable time in relation to detection of item placement into the smart shopping apparatus; at any suitable time in relation to other portions of embodiments of the method 100; during an entire shopping period, such as indicated by detected movement of the smart shopping apparatus, such as indicated by manual input from a user; etc.) and frequency.

However collecting sensor data S120 can be performed in any suitable manner.

### 3.3 Identifying Item Profiles.

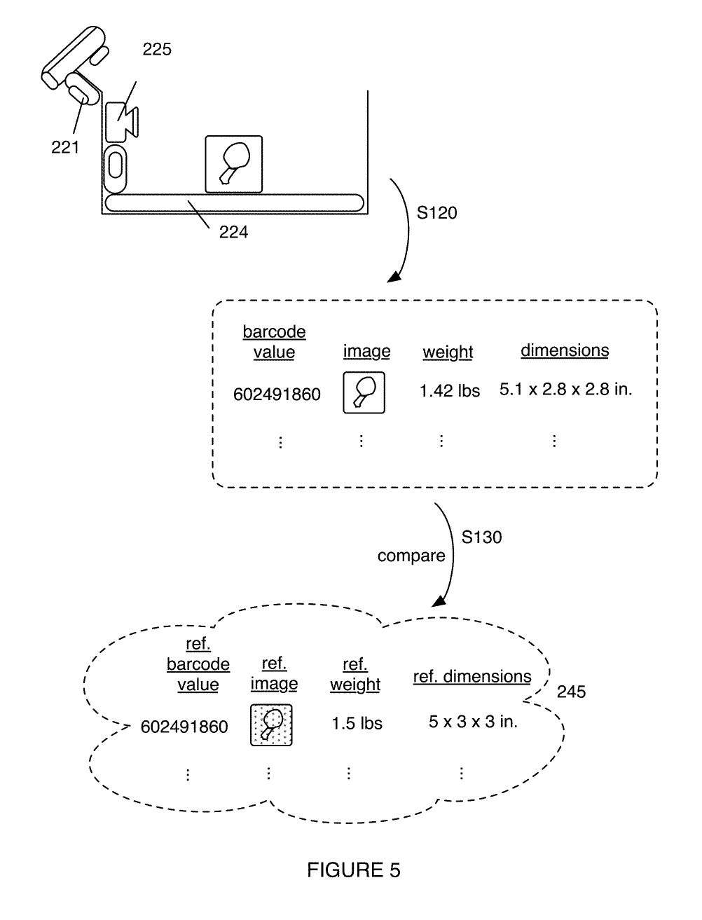

As shown in FIG. 5, embodiments of the method 100 can include identifying one or more item profiles describing the one or more items based on the sensor data (e.g., based on indications of item identifiers by the sensor data, etc.) S130, which can function to identify an item by mapping item identifiers (e.g., an item placed into and/or removed from the shopping apparatus) and/or other suitable item data to one or more item profiles (e.g., reference components of the one or more item profiles; etc.).

Item profiles preferably include reference components (e.g., reference item identifiers; known item identifiers; etc.) and include stored item profiles for different types of items (e.g., corresponding to different UPCs and/or other product codes, etc.). Item profiles preferably include reference item identifier data (e.g., known item identifiers stored as part of item profiles, for identifying the items corresponding to the item profiles; etc.) including reference item identifiers (e.g., describing a reference item corresponding to the item profile, where identifying the item profile preferably includes identifying the item profile corresponding to the reference item of the same item type as the item of interest; etc.), such as where types of reference item identifiers can include any suitable types of item identifiers (e.g., reference item identifiers including reference barcode values such as reference UPC codes, reference item characteristics such as reference item shape, weight, dimensions, etc.). Additionally or alternatively, item profiles can any suitable data described herein (e.g., user-specific item data associated with the type of item, such as purchase frequency for specific users, user groups, merchants, merchant stores; merchant data; inventory data; etc.).

Identifying the one or more item profiles corresponding to the one or more items is preferably based on collected sensor data, such as by comparing the sensor data (e.g., item characteristics derived from the sensor data) to item profile data (e.g., to identify the item profiles with greatest similarity, such as based on similarity scores, to the item characteristics indicated by the sensor data; etc.). In variations, identifying item profiles can be based on the same, a subset of, or different sensor data used in detecting item placement in relation to a smart shopping apparatus (e.g., where the same sensor data can be used as inputs into an placement detection model analyzing item placement in relation to a smart shopping apparatus, as well as inputs into an item profile model for identifying one or more item profiles corresponding to the items placed into and/or otherwise in relation to the smart shopping apparatus; etc.). In a specific example, optical sensor data (e.g., images, etc.) of an item being placed into a smart shopping apparatus can be used for both detecting the item placement into the smart shopping apparatus (e.g., through analyzing a set of images to detect movement of the item from outside the smart shopping apparatus to inside an item compartment of the smart shopping apparatus; etc.), as well as for identifying a corresponding item profile (e.g., using an image that captured an item identifier of the item, such as a barcode, etc.). In a specific example, weight sensor data can be used for both detecting the item placement into the smart shopping apparatus (e.g., detecting a change in weight of objects in the item compartment, corresponding to placement of a new item into the item compartment; etc.), as well as for identifying a corresponding item profile (e.g., using the change in weight as an indicator of the weight of the item, which can be compared to weight data stored in item profiles for identifying an item profile consistent with the item characteristics of the item; etc.).

In an example, the method 100 can include collecting image data of an item (e.g., from two or more cameras of the smart shopping apparatus; etc.), the image data including coverage of a barcode attached to the item (e.g., printed on the item packaging, etc.); extracting a barcode value (and/or other barcode data) (e.g., determining the UPC number and/or store code values based on character recognition algorithms); and mapping the barcode value (and/or other barcode data) to a corresponding reference barcode value (and/or other reference barcode data) included in a stored item profile (e.g., where the item associated with the user is identified as the item indicated by the item profile; etc.). In a specific example, the method 100 can include collecting image data for the item with an optical sensor of the smart shopping apparatus; and identifying an item profile for the item, where identifying the item profile includes in response to successfully detecting a barcode attached to the item based on the image data: extracting a barcode value for the item based on the image data; mapping the barcode value to a reference barcode value (e.g., known barcode value, etc.) from the item profile (e.g., matching an extracted UPC number to a reference UPC number from an item profile; etc.); and identifying the item profile based on the mapping. In a specific example, identifying the item profile can include (e.g., in relation to applying one or more sequence-based item profile models; etc.), in response to failing to detect the barcode attached to the item based on the image data: determining a first comparison between a reference weight from the item profile and an item weight measured by a weight sensor of the smart shopping apparatus; determining a second comparison between a reference image from the item profile and the image data; and identifying the item profile for the item based on the first comparison and the second comparison (e.g., identifying an item profile based on similarities in weight and appearance rather than barcode data, etc.).

In another example, the method 100 can include collecting image data of item (e.g., images of the item at different time points and perspectives; etc.), comparing the image data to stored image data of one or more item profiles; and selecting an item profile for the item based on the comparison (e.g., selecting the item profile associated with stored images with greatest similarity to the collected image data; etc.). In a specific example, the method 100 can include determining one or more item characteristics for one or more items (e.g., dimensions, weight, color, packaging, item contents, text, shape, size, barcode, quantity, etc.) based on the collected image data of the item; generating a comparison (e.g., through a convolutional neural network for image processing; through other artificial intelligence approaches; etc.) between the collected image data and/or item characteristics to stored image data (e.g., of one or more profiles) and/or stored item characteristics; and identifying one or more item profiles (and/or confirming one or more item characteristics) for the one or more items based on the comparison.

In another example, the method 100 can include determining a weight of an item; and identifying an item profile for an item based on comparing the collected item weight to reference item weights (e.g., known item weights) stored in item profiles.

In another example, the method 100 can perform a plurality of comparisons between collected data and components of item profiles (e.g., for improving accuracy in relation to item identification; etc.), such as performing comparisons that confirm a matching item and stored item profile in relation to barcode value, item appearance (e.g., indicated from images), weight, and/or any other suitable identifying information.

Additionally or alternatively, item identification (e.g., identifying one or more item profiles, etc.) can be based on one or more of: user inputs (e.g., a user input in response to prompting the user to select the correct item profile from a pool of item profiles determined to have the greatest probabilities of matching the item; user inputs indicating user inclinations towards specific items, such as users engaging with advertisements for specific items, where item profiles for such items can have an increased probability of matching the item placed in the smart shopping apparatus; shopping lists; etc.), contextual shopping-related data (e.g., user purchase histories; historic user behavior in relation to merchants, merchant stores; merchant data regarding purchase frequencies for items offered by the merchant; inventory data; etc.), and/or any other suitable data.

In variations, identifying one or more item profiles can include generating (e.g., training, etc.), applying, executing, updating, and/or otherwise processing one or more item profile models (e.g., outputting one or more item profiles corresponding to one or more items of interest; outputting data facilitating item profile identification, such as classifications of items; etc.), where item profile models and/or other portions of embodiments the method 100 (e.g., placement detection models, shopping parameter models, etc.) can employ artificial intelligence approaches (e.g., machine learning approaches, etc.) including any one or more of: supervised learning (e.g., using logistic regression, using back propagation neural networks, using random forests, decision trees, etc.), unsupervised learning (e.g., using an Apriori algorithm, using K-means clustering), semi-supervised learning, a deep learning algorithm (e.g., neural networks, a restricted Boltzmann machine, a deep belief network method, a convolutional neural network method, a recurrent neural network method, stacked auto-encoder method, etc.) reinforcement learning (e.g., using a Q-learning algorithm, using temporal difference learning), a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C 4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a dimensionality reduction method (e.g., principal component analysis, partial lest squares regression, Sammon mapping, multidimensional scaling, projection pursuit, etc.), an ensemble method (e.g., boosting, boostrapped aggregation, AdaBoost, stacked generalization, gradient boosting machine method, random forest method, etc.), and/or any suitable artificial intelligence approach. In an example, detecting the placement of the item into the smart shopping apparatus can include detecting the placement of the item into the smart shopping apparatus based on first sensor data and a placement detection; and identifying the item profile for the item can include identifying the item profile for the item based on second sensor data and an item profile model.

In examples, identifying an item profile can include applying a neural network model (e.g., a convolutional neural network model) and/or other suitable models for classification of the item of interest (e.g., item corresponding to the sample data collected; etc.), where classification can include any one or more of classifying: item identifiers (e.g., item characteristics such as item type and/or item category, such as “Fruit”, “Cereal”, etc.), item profiles (e.g., where the output of the model is a mapping of the item to one or more specific item profiles; etc.), and/or any other suitable aspects. In a specific example, identifying one or more item profiles can be based on applying an artificial intelligence model trained upon a set of images of different types of items and labeled with one or more item identifiers and/or item profiles, such as where the corresponding item profile model can compare features of the training dataset of images to features of images collected for an item of interest (e.g., an item placed into a smart shopping apparatus), in identifying one or more item profiles corresponding to the item of interest (e.g., a single item profile corresponding to the item of interest; a ranked list of potential item profiles, with associated confidence levels indicating confidence that the item profile correctly corresponds to the item; etc.). In an example, identifying an item profile can include applying an item profile model (e.g., with collected sensor data inputs, etc.) to classify an item category (e.g., “Canned Food”, etc.) for the item; and searching item identifiers corresponding to item profiles for items in the item category (e.g., searching UPC numbers corresponding to items in the “Canned Food” category to find a match with a UPC number identified by optical sensor data captured for the item; etc.), which can improve computational processing efficiency (e.g., by identifying a subset of item profiles to analyze out of a potentially vast pool of item profiles, etc.).

In variations, identifying one or more item profiles can include applying one or more sequence-based item profile models (e.g., decision tree models and/or other suitable models, etc.), such as for applying one or more approaches (e.g., different approaches, etc.) in a sequence, as needed, for determining one or more item profiles (e.g., performing additional approaches until an item profile is determined with a confidence level satisfying a threshold condition, etc.). In an example, applying a sequence-based item profile model can include applying a tiered analysis, such as including a set of approaches ranked in order of priority (e.g., where if a first approach is unsuitable to apply for item profile identification, the model applies a second approach, etc.). In a specific example, applying a sequence-based item profile model can include attempting an item barcode analysis (e.g., analyzing a set of images, captured by a set of optical sensors, for one or more item barcodes of an item placed into a smart shopping apparatus; searching for a UPC number; etc.); in response to a failure of the item barcode analysis (e.g., item barcode is out of the field of view of the optical sensors; item barcode is obstructed; item does not include a barcode; etc.) and/or other suitable analysis (e.g., failure of weight verification in response to barcode identification, such as where a barcode corresponded to an item profile weight inconsistent with an actual item weight detected by a weight sensor of a smart shopping apparatus; etc.), performing an analysis for a different item identifier (e.g., analyzing a set of images for a different item barcode, such as ISBN number, for other item identifiers such as physical item characteristics; etc.). In specific examples, failure of one or more item identification analysis can trigger presentation of one or more notifications to a user, such as including one or more of: a prompt to a user to manually input item identifiers (e.g., at a user interface of the smart shopping apparatus; at a user interface of a user device such as a user smartphone; etc.), where the item identifiers can identify one or more items associated with the shopping period (e.g., items placed into a smart shopping apparatus by the user but were not sufficiently identified by the smart shopping apparatus and/or related components; etc.); a notification alerting the user regarding aspects associated with the item profile identification, such as alerting the user to discrepancies between an item profile and sensor data (e.g., inconsistency between a weight stored in associated with an item profile, and a weight determining by a weight sensor of the smart shopping apparatus; etc.); a notification presenting a difference in cost due to discrepancies and/or other suitable aspects associated with the item profile determination; a notification prompting the user to initiate communication with one or more merchant entities (e.g., employees of the merchant store; a remote entity associated with the merchant; etc.); and/or any other suitable notifications. Additionally or alternatively, identifying one or more item profiles can include any suitable number of analyses that can be performed in any suitable sequences and/or in response to satisfaction and/or failure of any suitable conditions. Additionally or alternatively, any suitable sequence-based models can be performed for any suitable portions of embodiments of the method 100 (e.g., performing one or more tiered analyses for identifying item profiles, determining shopping parameters, facilitating purchase transactions, etc.).

In variations, different models (e.g., applying different algorithms; using different sets of features; associated with different input and/or output types; applied in different manners such as in relation to time, frequency, component applying the model; generated with different approaches; etc.) can be generated, selected, retrieved, executed, applied, and/or otherwise processed based on one or more of: item identifiers (e.g., applying a first item profile model for items of a first category such as items displaying one or more barcode identifiers that can be analyzed by the first item profile model with image data of the barcode identifiers; and applying a second item profile model for items of a second category such as items without barcode identifiers that can be analyzed by the second item profile model based on weight, physical item characteristics, and/or other suitable aspects; etc.), satisfaction of threshold conditions (e.g., using a second item profile model evaluating item weight in response to failure to apply a first item profile model evaluating images of the item, such as where a barcode identifier of the item is obstructed from a camera of the smart shopping apparatus; etc.); sensor data (e.g., using a first item profile model for weight sensor data; using a second item profile model for image data; etc.); users (e.g., using different models for different users based on user preferences associated with the shopping period, such as using different shopping parameter models for different users based on determining shopping parameters of interest to a particular user; etc.); merchant stores (e.g., using shopping parameter models tailored to preferences of the merchant store; etc.); and/or any other suitable criteria. However, any suitable number and/or types of models can be applied in any suitable manner based on any suitable criteria.

In variations, the method 100 can include chaining one or more models. For example, outputs (e.g., raw outputs, processed outputs processed using one or more processing operations, etc.) of a first model can be used as inputs for a second model. In a specific example, outputs of a detection placement model (e.g., confirmation of item placement into a smart shopping apparatus; data describing item placement into the smart shopping apparatus; etc.) can be used as inputs into an item profile model, and outputs of the item profile model (and/or detection placement model) can be used as inputs into a shopping parameter model. However, chaining models can be performed in any suitable manner.

Any suitable models (e.g., placement detection models; item profile models; shopping parameter models; security process models for facilitating application of security processes; etc.) can be run or updated: once; at a predetermined frequency (e.g., every 24 hours, week, month, etc.); every time a portion of an embodiment of the method 100 is performed (e.g., in response to a manual input by a user indicating an incorrect item profile identification; indicating a lack of item placement detection in relation to the smart shopping apparatus; indicating issues with shopping parameter determination; etc.); every time a trigger condition is satisfied (e.g., detection of an unanticipated measurement; determination of confidence levels below a threshold, in relation to any suitable portion of embodiments of the method 100; etc.), and/or at any other suitable time and frequency. Models can be run or updated concurrently with one or more other models, serially, at varying frequencies, and/or at any other suitable time. Each model can be validated, verified, reinforced, calibrated, or otherwise updated based on newly received, up-to-date data; historical data or be updated based on any other suitable data.

Identifying one or more item profiles describing the one or more items can be performed by any one or more of shopping apparatus processing systems, remote computing systems, remote merchant processing systems, user devices, and/or any other suitable processing devices.

For example, sensor data transmitted to a shopping apparatus processing system can be compared, by the shopping apparatus processing system, to item profiles stored at an item database (e.g., received by the shopping apparatus processing system from a remote computing system and/or remote merchant processing system, etc.) of the shopping apparatus processing system.

In another example, collected sensor data can be transmitted from the shopping apparatus processing system to remote computing system for comparison to item profiles (e.g., item profiles stored by the remote computing system, such as in association with the merchant and/or merchant store in which the user located; item profiles retrieved from a remote merchant processing system, such as through an API, etc.), where the identified item profile and/or associated data (e.g., price; total price accumulate over the shopping period for the user; related items; advertisements; offers; etc.) can be transmitted to the smart shopping apparatus (e.g., from the remote computing system, from the remote merchant processing system, etc.) and/or other suitable components (e.g., user mobile device, etc.).

However, identifying one or more item profiles for one or more items S130 can be performed in any suitable manner.

### 3.4 Determining Shopping Parameters.

Embodiments of the method 100 can include determining one or more shopping parameters associated with the shopping period, based on the one or more item profiles S140, which can function to determine parameters informative of, describing, and/or otherwise associated with the shopping period to improve the user experience, merchant operation, and/or other suitable related aspects.

Shopping parameters can include any one or more of: item data (e.g., from item profiles; item identifiers; nutrition facts, price data, recommended and/or related items, etc.); shopping list data (e.g., indications of progress in completing a shopping list, such as in response to placement of an item on the shopping list into the smart shopping apparatus; etc.), food-related data (e.g., recipes, recommended and/or related food items, etc.), advertisement data (e.g., advertisement content, advertisement delivery parameters, offers such as coupons, personalized offers and/or advertisement content, etc.), rewards program parameters (e.g., effect of item purchases on rewards program status; potentially obtainable rewards based on items in the smart shopping apparatus and/or potential items; etc.), route data (e.g., for guiding the user to locations within the merchant store; for locating items such as items on a shopping list and/or recommended items; for offering rewards program benefits such as for visiting different locations with the merchant store; maps of the store; etc.) and/or any other suitable parameters.

In an example, shopping parameters can include a shopping list corresponding to recipe item fulfillment, where the shopping list can include items, quantities, prices, and/or any other data (e.g., route data, etc.), such as determined from recipes and/or associated food-related options (e.g., food preferences, number of people to cook for, how many meals, how many courses, food allergies, etc.) selected by a user (e.g., at a mobile computing device application associated with the smart shopping apparatuses, etc.). In another example, shopping parameters can include augmented shopping list data derived from user-determined and/or machine-generated shopping lists (e.g., augmenting a user selection of items in the shopping list with prices, locations, recommendations, and/or other suitable item data corresponding to a particular merchant store; etc.).

In another example, shopping parameters can included price data associated with one or more items in the smart shopping apparatus (e.g., a cumulative price total for all of the items in the smart shopping apparatus, such as a price total updated in real-time as items are placed in and/or removed from the smart shopping apparatus; individual prices for individual items or subsets of items in the smart shopping apparatus; price totals for different combinations of items, such as combinations of items including items recommended to a user; recommendations for reducing and/or otherwise modifying price totals; etc.).

In another example, shopping parameters can include shopping analytics metrics for presentation to merchants, users, manufacturers, distributors, inventory managers, advertising agencies, and/or any other suitable entities. Shopping analytics metrics can include any one or more of: user behavioral data (e.g., user routes taken through merchant stores; user purchase histories; user interactions with user interfaces of the smart shopping apparatus and/or other devices; user interactions with items, such as placements into and/or removals from the smart shopping apparatus; user interactions with an entry and/or exit bay associated with the merchant store; associated temporal indicators describing the time points of different events associated with the user; etc.); inventory analytics (e.g., change in inventory over time; trends; seasonal changes in sales velocity for different items; etc.); advertising analytics (e.g., advertising performance associated with the smart shopping apparatus, such as for advertisements displayed through the user interface of the smart shopping apparatus; etc.), and/or any other suitable shopping analytics metrics.

Determining one or more shopping parameters is preferably based on one or more item profiles identified for one or more items. For example, updating a cumulative price total can be based on the prices included in the item profiles identified for the items placed into the smart shopping apparatus. In another example, determining recommended items, advertisements, and/or other suitable notifications to present to the user (e.g., at the user interface) can be based off of the item data included in the item profiles (e.g., recommending a peanut butter item on sale in the merchant store in response to identifying a bread item profile for a bread item placed into the smart shopping apparatus; etc.).

Additionally or alternatively, determining shopping parameters can be based on one or more of: collected sensor data (e.g., generating route data for guiding the user to a specific target location based on a current location of the user; etc.), user inputs (e.g., retrieving and displaying item data for an item profile selected by a user, such as for an item presented in an advertisement; etc.), contextual shopping-related data (e.g., targeted advertisements based on historic user behavior, current user location within merchant store as indicated by location sensors of the smart shopping apparatus, and types of items located proximal the current user location, etc.), and/or any other suitable data.

Determining shopping parameters can be performed by any one or more of shopping apparatus processing systems, remote computing systems, remote merchant processing systems, user devices, and/or any other suitable components.

In variations, determining shopping parameters include generating (e.g., training, etc.), applying, executing, updating, and/or otherwise processing one or more shopping parameter models (e.g., outputting one or more shopping parameters; etc.), such as shopping parameter models employing artificial intelligence approaches described herein. Different shopping parameter models can be applied for different types of shopping parameters (e.g., a first shopping parameter model for determining item data; a second shopping parameter model for determining advertisement data; etc.), different types of item profiles (e.g., different types of input data from identified item profiles, can be used for different types of shopping parameter models; etc.), and/or for different types of any suitable components.

Shopping parameters can be presented to the user through notifications transmitted to one or more user interfaces of the smart shopping apparatus, to user devices (e.g., mobile computing device of the user), to a merchant store device (e.g., display screens located in the merchant store), and/or any suitable components. Transmitting notifications (e.g., including shopping parameters and/or other suitable data, etc.) can be performed in temporal relation to a condition (e.g., in response to identifying matching item profiles; in response to detecting a user location at a predefined target merchant store location; etc.), and/or at any time and frequency. Additionally or alternatively, the notifications can be displayed for any suitable time period. However, notifications can include any suitable data for facilitating the shopping period of the user, and can be applied in any suitable manner.

However, determining shopping parameters S140 can be performed in any suitable manner.

### 3.5 Facilitating a Purchase Transaction.

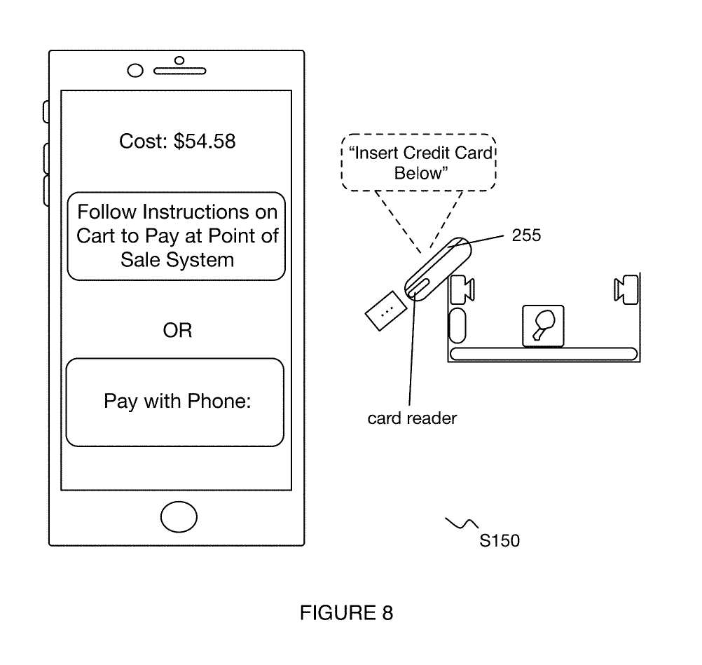

As shown in FIG. 8, embodiments of the method 100 can include facilitating a purchase transaction for the one or more items based on one or more of the shopping parameters S150, which can function to facilitate one or more user purchases and/or the collection of (e.g., into bags and/or other item containers for the user to keep and/or leave the merchant store with; etc.) the one or more items, inventory reconciliation, data updates, and/or other related processes.

A purchase transaction can include any one or more of a point of sale transaction, an inventory-related process (e.g., inventory update, etc.), financial transaction, an item collection process (e.g., for users to collect the items from the smart shopping apparatus, etc.), physical item purchase, digital item purchase, an online purchase transaction (e.g., completed remotely from the corresponding merchant store; etc.), a physical purchase transaction (e.g., completed in a merchant store; etc.), and/or any other suitable related processes.

In a variation, facilitating a purchase transaction can include enabling a point of sale transaction for the purchase of the one or more items. Enabling the point of sale transaction can include any one or more of: providing payment options (e.g., payments through a user device, such as through an application executing on the user device, where the user device can communicate with the smart shopping apparatus and/or other suitable entities for facilitating payment; credit card and/or other type of card payments, such as through a credit card reader of the smart shopping apparatus and/or credit card reader located within and/or proximal the merchant store, such as at an entrance bay and/or exit bay; facilitating payment through a point of sale system, such as through communication with the point of sale system by the smart shopping apparatus; etc.); initiating a check-out process (e.g., instructions presented at the user interface of the smart shopping apparatus and/or other suitable device; in response to location sensor data indicating a user location and/or smart shopping apparatus location at an exit bay of the merchant store; etc.); initiating security processes (e.g., closing a lid of the smart shopping apparatus until the point of sale transaction is successfully completed; etc.); transmitting payment-related data (e.g., shopping parameters indicating the item profiles and/or associated data, such as item identifiers, prices, etc.) to a remote merchant processing system, a point of sale system, a payment entity, and/or other suitable entity (e.g., through a wireless communication module of the smart shopping apparatus, such as through WiFi, etc.); presenting confirmation of purchase (e.g., transmitting a receipt to the user, such as from the smart shopping apparatus to an email address of the user; presenting confirmation and/or a receipt at a user interface of the smart shopping apparatus; etc.); bagging and/or other transfer of items to a user (e.g., automatically triggered displacement of items from the smart shopping apparatus to one or more bags and/or other item containers for a user to take; sealing, such as thermally sealing, and/or other applying other closing mechanisms for bags; prompting the user to manually bag the items, such as through guiding the user to a bagging location; etc.); and/or any other suitable processes for facilitating point of sale transactions. Enabling a point of sale transaction can be performed in temporal relation to a condition (e.g., user location approaching, within, or exiting an exit bay and/or other suitable location; during the check-out process; during portions of the point-of-sale transaction; etc.), and/or at any suitable time and frequency.

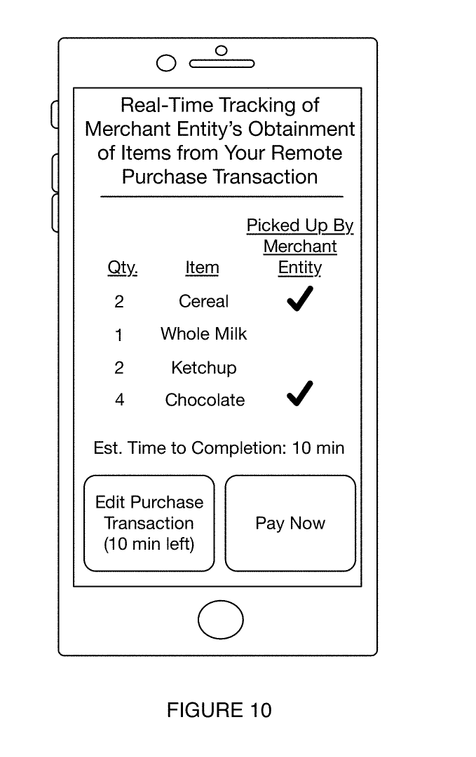

In variations, facilitating purchase transactions can be performed proximal a merchant store (e.g., in a merchant store, etc.), remotely (e.g., through an online interface associated with processes of embodiments of the method 100; through a user interface for a user device; etc.), and/or at any suitable locations. In examples, facilitating a purchase transaction proximal a merchant store can include facilitating a purchase transaction at one or more of a checkout area (e.g., designated for bagging and/or other transfer of items to a user; designated for processing a point of sale transaction; etc.), a shopping area (e.g., where users can view and/or place items into a shopping apparatus; where a majority of items of the merchant store are located; etc.), inside a merchant store, outside a merchant store (e.g., at a drive-through window of the merchant store; etc.), another geographically defined area (e.g., a geofence covering any suitable region associated with the merchant store; etc.), and/or at any suitable areas. In a specific example, facilitating a remote purchase transaction (e.g., online purchase transaction) can include: receiving a remote purchase transaction for a set of items; monitoring obtainment of the set of items at a merchant store (e.g., collecting smart shopping apparatus sensor data indicating progress of obtainment of the set of items, such as in relation to placement of items of the set of items into the smart shopping apparatus; etc.); determining one or more shopping parameters based on the monitoring (e.g., updating a total cost; updating a shopping list indicating which items have been placed into the smart shopping cart; generating notifications indicating the progress of the item obtainment and/or other suitable aspects associated with fulfillment of the remote purchase transaction; as shown in FIG. 10; etc.); and/or transmitting the one or more shopping parameters (e.g., in real-time or substantially real-time, etc.) to the user. In a specific example, the method 100 can include detecting the placement of the item into the smart shopping apparatus by a merchant entity distinct from (e.g., and remote from, etc.) the user (e.g., based on sensor data; etc.); and facilitating a remote purchase transaction completed by the user, where facilitating the remote purchase transaction includes, in response to determining the shopping parameter (e.g., a shopping parameter describing fulfillment of the remote purchase transaction, such as a progress update regarding obtainment of items purchased, an update of total cost, an option to modify the items to be purchased; etc.), transmitting the shopping parameter to a user device associated with the user (e.g., for presentation of the shopping parameter to the user at the user device; etc.).

In a specific example, purchase transaction parameters (and/or other suitable data) can be transmitted to the smart shopping apparatus (e.g., for receipt at a communication module; for receipt from a remote computing system in communication with a user device, such as through an application executing on the user device; etc.) for facilitating purchase transactions (e.g., where data transmitted to the smart shopping apparatus can be displayed on a corresponding user interface of the smart shopping apparatus such as to guide a user, merchant store entity, and/or other suitable entity in fulfilling a purchase transaction and/or for otherwise facilitating a shopping period; etc.). In a specific example, facilitating purchase transactions can include enabling a user to modify (e.g., in real-time, etc.) one or more purchase transactions (e.g., modifying items to be purchased), such as before, during, and/or after processes associated with fulfillment of the purchase transactions (e.g., obtainment of the items by a self-moving smart shopping apparatus; obtainment of the items by a merchant store entity such as a delivery-facilitation entity and/or pick-up-facilitation entity; etc.). However, facilitating purchase transactions can be performed in any suitable manner relative a merchant store, and/or at any suitable locations.

In a variation, facilitating a purchase transaction can include facilitating inventory reconciliation, such as through one or more of: transmitting shopping parameters (e.g., item profiles and/or associated data, such as item identifiers, of items purchased; etc.) and/or other suitable data (e.g., user data associated with the corresponding shopping period; prices of items purchased; offers redeemed; etc.) to a remote merchant processing system (e.g., inventory management system employed by the merchant; etc.) for the remote merchant processing system to update inventory; updating inventory data at a remote computing system associated with the smart shopping apparatus; and/or through any other suitable processes. Facilitating inventory reconciliation is preferably performed in response to successful completion of a point of sale transaction, but can be performed at any suitable time and frequency.

However, facilitating a purchase transaction S150 can be performed in any suitable manner.

### 3.6 Applying Security Processes.

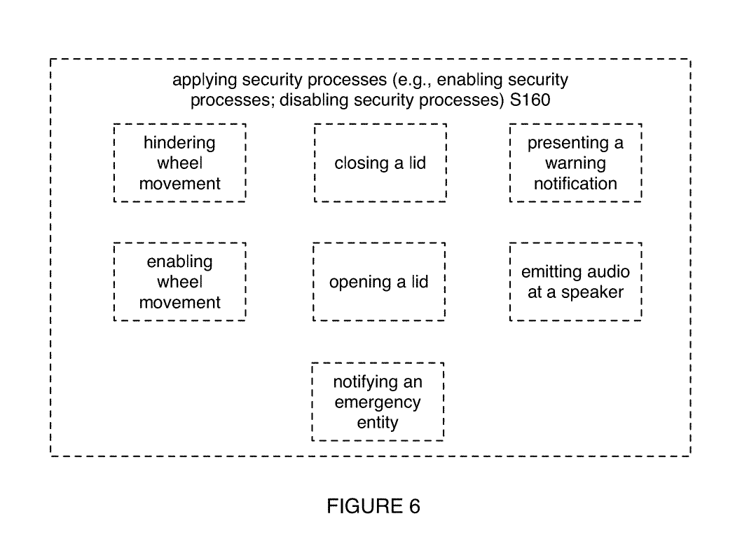

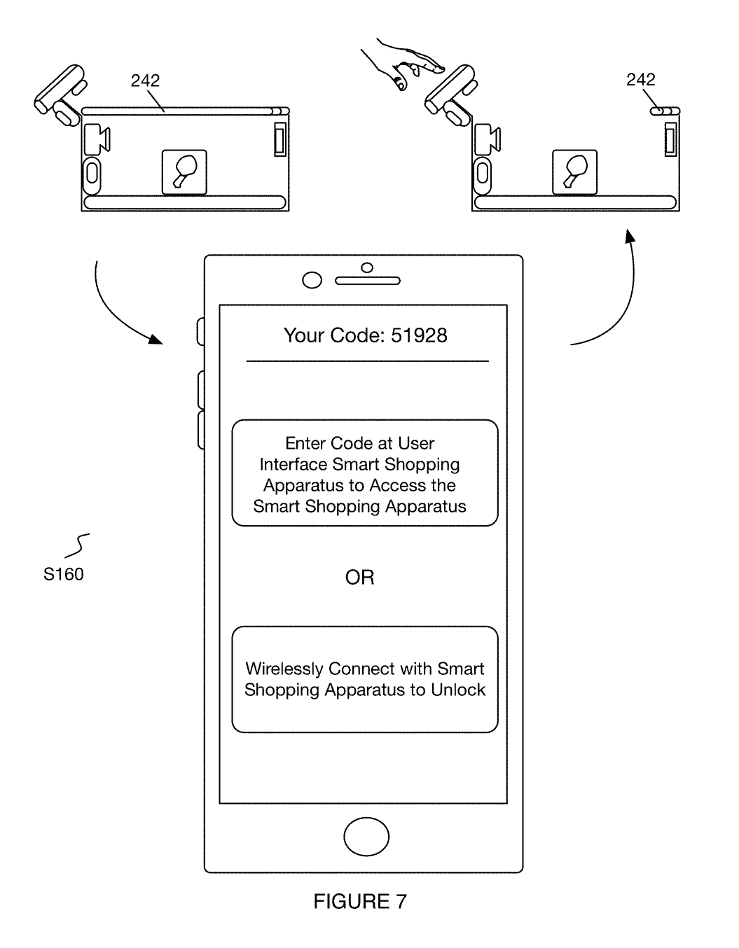

As shown in FIGS. 6-7, embodiments of the method 100 can additionally or alternatively include applying security processes S160, which can function to hinder item theft, hinder tampering of the smart shopping apparatus and/or other suitable components, and/or enable any other suitable security goal.

Applying security processes can include any one or more: transforming one or more components (e.g., mechanical components, etc.) of the smart shopping apparatus (e.g., closing a lid of the smart shopping apparatus to prevent item collection by a user, such as in response to a user location approaching or within an exit bay such as a checkout area, opening the lid if a user returns to the shopping area of the merchant store and the user has not successfully completed the check-out process; maintaining a closed position for the lid if the user has successfully completed check out and is returning to the shopping area; hindering movement of wheels of the smart shopping apparatus, such as through enablement of a “park” selection for the smart shopping apparatus; etc.); presenting security-related notifications (e.g., warning notifications indicating incompletion of check-out process; audio warnings, such as emitted through speakers of the smart shopping apparatus, of the merchant store, of a user device executing an associated application; graphical warnings, such as presented through the user interface of the smart shopping apparatus and/or other component; etc.); facilitating manual security measures (e.g., notifying security guards, notifying emergency personnel such as police officers, etc.); enabling and/or disabling security buttons and/or chips associated with the items and/or the smart shopping apparatus (e.g., using the smart shopping apparatus processor and communication module to wireless communicate with and disable radio-frequency identification security buttons and/or chips in response to detecting successful completion of a purchase transaction, etc.); selectively activating and/or deactivation a smart shopping apparatus and/or associated applications (e.g., in response to initiation and/or completion of a shopping period, which can improve security by reducing tampering outside of shopping periods; etc.); and/or any other suitable security-related processes.

In an example, the method 100 can include transforming a mechanical component of the smart shopping apparatus based on verification of the purchase transaction (e.g., in response to successfully verifying completion of the purchase transaction), where the mechanical component can include at least one of a set of wheels, a lid for an item compartment of the smart shopping apparatus, and a speaker. In a specific example, transforming the mechanical component can include disabling a security process associated with the mechanical component based on the verification of the purchase transaction, where disabling the security process can include at least one of unlocking at least one wheel of the set of wheels, opening the lid for the item compartment of the smart shopping apparatus, and emitting, with the speaker, audio associated with the verification of the purchase transaction (e.g., audio confirming the verification of the purchase transaction, etc.). In a specific example, transforming one or more components (e.g., mechanical components, etc.) of the smart shopping apparatus can include locking a right-front wheel and a left-rear wheel, and/or any suitable combination of wheels. In a specific example, the method 100 can include facilitating a purchase transaction at a shopping area (e.g., where facilitating purchase transactions outside of the checkout area can improve purchase transaction wait times associated with merchant stores; etc.) of a merchant store (e.g., when a user has obtained each of the items on their shopping list; etc.); in response to verifying the purchase transaction, initiating a security process for the smart shopping apparatus (e.g., closing a lid of the item compartment of the smart shopping apparatus, such as to inhibit placement of additional items, post-payment, into the item compartment; etc.). In a specific example, applying security processes can include ceasing a security process for the smart shopping apparatus in response to verification of a purchase transaction and detection of the user at a checkout area and/or other suitable area (e.g., opening a lid of the smart shopping apparatus to enable the user to transfer purchased items from the smart shopping apparatus to item containers, such as bags, that a user can take; such as where a user can bypass one or more aspects of a checkout area, such as a checkout line, by performing a purchase transaction prior to entering the checkout area; etc.), such as where detection of the user at the checkout area and/or other suitable area can be based on location sensor data associated with the user (e.g., from location sensors of the smart shopping apparatus; from location sensors of the user device; etc.) and geographically defined areas (e.g., geofence coordinates that can be compared to user coordinates extracted from the location sensor data; entry bays; exit bays; etc.). In an example, the method 100 can include facilitating a purchase transaction, where facilitating the purchase transaction includes, facilitating, with a point of sale system of the smart shopping apparatus, the purchase transaction (e.g., a point of sale transaction, etc.) for the user at a shopping area of a merchant store associated with the shopping period, where the shopping area is distinct from a checkout area of the merchant store; and in response to verification of the purchase transaction (and/or other suitable condition associated with the purchase transaction), applying a security process with the smart shopping apparatus (e.g., transforming a mechanical component, such as closing a lid of the item compartment; etc.) to hinder placement of additional items into the smart shopping apparatus.

In an example, presenting security-related notifications can include emitting audio notifications (e.g., at one or more speakers of the smart shopping apparatus and/or related components such as a docking hub; at one or more speakers of the merchant store; at one or more speakers of a user device; etc.). In a specific example, emitting audio notifications can include emitting progressively louder audio warnings, if a purchase transaction has not been completed (e.g., a user has failed to pay for items placed into a corresponding smart shopping apparatus; etc.), and as the distance increases between an area of a merchant store (e.g., an exit area, a checkout area, a central area, etc.) and the location of a smart shopping apparatus, user, and/or other associated entity. Additionally or alternatively, emitting audio notifications and/or other suitable security processes can be based on any suitable location-related conditions, purchase transaction conditions, and/or other suitable conditions.

In variations, applying security processes (and/or performing any other suitable portions of embodiments of the method 100, such as triggering an application startup process, initiating a check-out process, etc.) can be based on one or more entry bays and/or exit bays. Entry bays and/or exit bays preferably include a geographically defined area (e.g., a geofence; an area defined by coordinates; an area defined based on beacon data, ultra-wide bandwidth data, and/or other suitable location data, etc.) within and/or proximal to the merchant store (e.g., locationally defined proximal entrances and/or exits of the merchant store, etc.) associated with the user shopping period, but can be located at any suitable location in relation to the merchant store and/or other suitable components (e.g., a geographic area defined relative a docking station, etc.). The entry bays and/or exit bays are preferably a virtually defined area (e.g., a virtual perimeter) associated with the merchant store, but can additionally or alternatively by physically defined (e.g., using physical indicators of boundaries, etc.). User location in relation to entry bays and/or exit bays is preferably trackable through location sensor data corresponding to location sensors of the smart shopping apparatus, but can additionally or alternatively be identifiable based on other location sensor data (e.g., from a user device, from sensors of the merchant store, etc.), and/or any other suitable data (e.g., contextual shopping-related data indicating historic user route behavior to inform the likeliness of a user's location in relation to an entry and/or exit bay at a given time point in the shopping period, etc.). However, entry bays and/or exit bays can be configured in any suitable manner, and initiating security processes and/or performing any portions of embodiments of the method 100 based on and/or in relation to entry bay and/or exit bays can be configured in any suitable manner.

In an example, applying security processes can include facilitating a parking mode for one or more smart shopping apparatuses, which can function to allow a user to securely park a smart shopping apparatus (e.g., a smart shopping apparatus that the user has been using during a shopping period, etc.), such as to hinder theft and/or tampering from other users when a user is away from the smart shopping apparatus. Facilitating parking mode can include applying one or more security processes described herein, such as disabling movement of wheels of the smart shopping apparatus, securely closing a lid of the smart shopping apparatus, presenting notifications (e.g., blinking lights, a graphical notification displayed at the user interface of the smart shopping apparatus, etc.), and/or other suitable processes. In an example, applying security processes can include facilitating a parking mode for a first smart shopping apparatus associated with a user, and initiating new shopping period processes (e.g., additional instances of portions of embodiments of the method wo, etc.) for a second smart shopping apparatus for the user, which can function to allow a user to return to shopping at the merchant store for a second shopping period after a user has completed a first shopping period (e.g., without the user having to leave and return to the merchant store, etc.). In another example, facilitating a parking mode can include disabling a parking mode (e.g., disabling security processes that were initiated for the parking mode, such as re-enabling movement of wheels, opening lids, changing notifications, etc.), which can be based on sensor data (e.g., disabling a parking mode as a user approaches the smart shopping apparatus associated with the user and/or user device, such as indicated by optical data, location data, and/or other suitable data, etc.), user inputs (e.g., where a user receives a code and/or token, such as through a user interface and/or through a communication to the user device, in response to initiating parking mode, and where the user can input the code, such as through the user interface and/or through the user device, to disable parking mode such as to re-open a closed lid, as shown in FIG. 7; such as through options presented on the user device and/or user interface; through wireless and/or wired pairings between components of the system, such as a wireless Bluetooth pairing between the smart shopping apparatus and a recognized user device previously associate with the smart shopping apparatus; etc.), and/or any other suitable data described herein. In a specific example, facilitating a parking mode can include transmitting a code and/or token to a user (e.g., transmitting to user device such as a smart phone; transmitting a code and/or token with an expiration, such as a 24-hour expiration for active user; transmitting random codes and/or tokens for facilitating a user to uniquely access their corresponding smart shopping apparatus used for their shopping period; etc.) for disabling a parking mode of the smart shopping apparatus. In another example, parking mode and/or other suitable operation modes can be restricted to when the smart shopping apparatus resides in a particular location (e.g., entry bays and/or exit bays, etc.), and/or can otherwise conditioned upon data described herein. However, facilitating parking modes can be performed in any suitable manner.

In another variation, applying security processes can be performed in response to and/or with any suitable temporal relationship to verifying a purchase transaction (e.g., verifying that items described in a purchase transaction match the items in the smart shopping apparatus and/or collected by the user, etc.).

However, applying security processes S160 can be performed in any suitable manner.

### 3.7 Facilitating Improved Delivery.

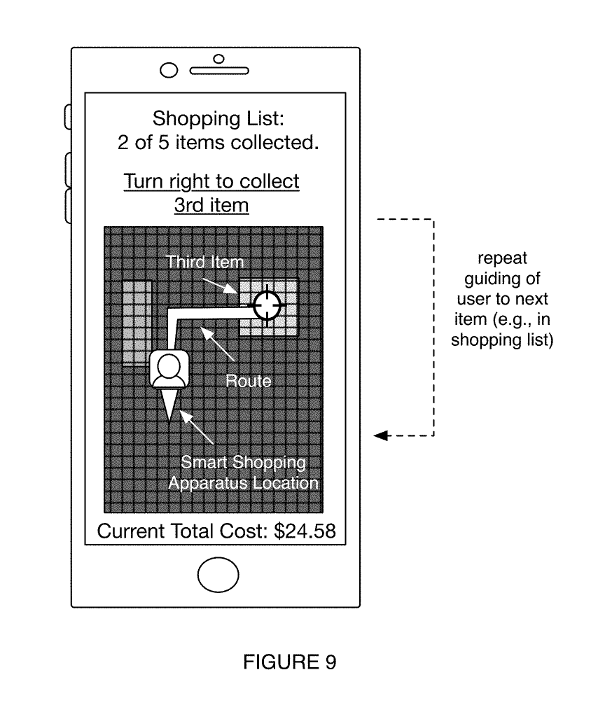

Embodiments of the method 100 can additionally or alternatively include facilitating improved delivery for the one or more items to the user S170, which can function to improve convenience associated with user receipt of the one or more items. In variations, facilitating improved delivery can include one or more of: enabling user collection of items through a drive-through process associated with the merchant store (e.g., where items of interest can be selected and/or pre-purchased by a user, such as through a digital shopping list, and the selected items can be retrieved from locations in the merchant store by an individual, mechanical device, and/or robotic device, for storage and convenient pick-up by the user, where the item retrieval can be improved through use of the smart shopping apparatus, and where a user can track the item retrieval in real-time to monitor progress, cost, and/or other suitable metrics; where the user and/or a third party service can pick up the items to facilitate receipt of the items for the user; etc.); guiding user collection of items with a smart shopping apparatus, based on routing data (e.g., displaying, at a user interface of the smart shopping apparatus, route guidance for a merchant store, where the route guidance can be tailored for different optimization parameters, such as shortest possible route to collect one or more of items, item discovery, viewing of sale items, viewing of items selected based on user preference, route for accommodating physical characteristics and/or suitable preferences of a user, route for optimizing time, cost, health, and/or other suitable parameters; as shown in FIG. 9; etc.); and/or any other suitable processes. In a specific example, the method 100 can include prior to detecting the placement of the item into the smart shopping apparatus: collecting first location sensor data from a location sensor of the smart shopping apparatus, the first location sensor data describing the location of the smart shopping apparatus; and guiding the user through a merchant store to an item location of the item based on the first location sensor data; and in response to determining the shopping parameter: collecting second location sensor data from the location sensor; and guiding the user through the merchant store to an additional item location of an additional item (e.g., an additional item of a shopping list associated with the user, etc.) based on the second location sensor data.

In a specific example, the method 100 can include facilitating a remote purchase transaction (e.g., an online purchase transaction; etc.); facilitating obtainment of corresponding items with a smart shopping apparatus at a merchant store (e.g., guiding an employee and/or smart shopping apparatus at the merchant store to obtain the items; etc.); in response to obtainment of the items, applying a security process for the smart shopping apparatus (e.g., closing the lid of an item compartment of the smart shopping apparatus; etc.); and enabling the user to pick-up the obtained items (e.g., sending a code and/or token to the user for opening the lid of the item compartment when the user arrives at the merchant store; sending a code and/or token that the user can provide at a drive-through window and/or provide for facilitating a drive-through process; etc.). However, facilitating improved delivery S170 can be performed in any suitable manner.

### 4. System

Embodiments of a system 200 can include a smart shopping apparatus 210 including one or more of an item compartment 215, a sensor set 220, a shopping apparatus processing system 228, a communication system 230, a user interface 235, wheels 244, a lid 242, a power system (e.g., for powering the components of the smart shopping apparatus 210), and/or other suitable components.

In a specific example, a system 200 for improving a shopping period for a user in relation to an item, can include: a smart shopping apparatus 210 including: an item compartment 215 sized to hold the item, the item compartment 215 including an opening for placement of the item into the item compartment 215; a sensor set 220 coupled to the item compartment 215, the sensor set 220 including: a first sensor 220′ for collecting first sensor data describing the placement of the item into the item compartment 215; and a second sensor 220″ for collecting second sensor data describing an item identifier of the item; a shopping apparatus processing system 228 configured to: receive the first sensor data; receive the second sensor data; detect the placement of the item into the item compartment 215 based on the first sensor data; facilitate identification of an item profile for the item based on the second sensor data; and determine a shopping parameter associated with the shopping period, based on the item profile for the item.

Additionally or alternatively, the system 200 can include a remote computing system 245, a docking station 250, a point of sale system 255 (e.g., for facilitating purchase transactions, etc.), and/or any other suitable components.

The system and/or portions of the system can entirely or partially be executed by, hosted on, communicate with, and/or otherwise include: a remote computing system 245 (e.g., a server, at least one networked computing system, stateless, stateful; etc.), a local computing system, user devices (e.g., mobile computing system; devices that can perform processing associated with portions of embodiments of the method 100; etc.), databases (e.g., item databases, smart shopping apparatus databases, user databases, inventory databases, merchant-associated databases, etc.), application programming interfaces (APIs) (e.g., for accessing data described herein, etc.), and/or any suitable component. Communication by and/or between any components of the system can include wireless communication (e.g., WiFi, Bluetooth, radiofrequency, etc.), wired communication, and/or any other suitable types of communication (e.g., facilitated by the communication system 230, etc.).

The components of the system 200 can be physically and/or logically integrated in any manner (e.g., with any suitable distributions of functionality across the components, such as in relation to portions of embodiments of the method 100; etc.). In variations, components of the system 200 can be positioned at (e.g., mounted at, integrated with, etc.) any suitable location (e.g., of the smart shopping apparatus 210, of the item compartment 215, etc.). Additionally or alternatively, components of the system 200 can be integrated with any suitable existing components (e.g., existing shopping apparatuses, existing merchant stores, etc.).

Components of the system 200 can be manufactured using any one or more of: microlithography, doping, thin films, etching, bonding, polishing, patterning, deposition, microforming, treatments, drilling, plating, routing, and/or any other suitable manufacturing techniques. Components of the system can be constructed with any suitable materials, including plastics, composite materials, metals (e.g., steel, alloys, copper, etc.), glass, ceramic, and/or any other suitable materials.

Components of the system 200 (e.g., item compartments 215, lids 242, wheels 244, etc.) and/or combinations of components of the system (e.g., sensors 220 integrated with item compartments 215, etc.) can include any suitable form factor including any suitable type and number of shapes, including any one or more of: cylinders, cubes, cuboids, spheres, cones, pyramids, prisms, circles, squares, rectangles, ellipses, triangles, hexagons, polygons, quadrangles, shapes with concave regions, shapes with parabolic regions, and/or any suitable multi-dimensional shapes (e.g., with any suitable number of edges, vertices, faces, sides, dimensions, etc.) with any suitable areas and/or volumes. Components and/or combinations of components of the system 100 can be characterized by any lengths, widths, heights, depths, radiuses, circumferences, and/or any amounting to any suitable dimensions, which can correspond to any suitable areas, volumes, and/or other suitable multi-dimensional characteristics.

However, the system 200 can be configured in any suitable manner.

### 4.1 Item Compartment.

Embodiments of the system 200 can include one or more item compartments 215, which can function to hold, support, physically interface with, and/or otherwise be physically associated with one or more items (e.g., placed into the item compartment 215 by the user during a shopping period), act as a base and/or physical connection region for one or more components (e.g., sensor set 220; shopping apparatus processing system 228; physical mounting region for one or more components of the system 200; etc.), and/or have any other suitable functionality. The item compartment 215 can be of any suitable size and shape (e.g., item compartment 215 of a cart, push apparatus compartment, carry basket compartment, trolley compartment, compartment with handles, bag compartment, etc.), such as a size and/or shape adapted to holding and/or otherwise carrying any number and/or type of items. For example, the item compartment 215 (and/or other suitable components of the system) can be shaped and/or be integrated with one or more shopping basket compartments, such as a shopping basket compartment with handles for convenient carrying. In another example, the item compartment 215 can possess a cubic shape with a retractable lid 242 proximal an opening through which items can enter and/or exit the item compartment 215. In a specific example, the item compartment 215 can be constructed with substantially rigid materials (e.g., for a smart shopping cart and/or smart shopping basket, etc.). In a specific example, the item compartment 215 can be constructed with substantially flexible materials (e.g., for a smart shopping bag, etc.). However, the item compartment 215 and/or other suitable components can be constructed with any suitable materials with any suitable properties.

The item compartment 215 can include wiring and/or other suitable components for facilitating operation of other system components (e.g., shopping apparatus processing system 228, etc.). In variations, the item compartment 215 can include item bags (and/or other suitable item containers) residing within, mounted to, and/or otherwise physically associated with the item compartment 215. However, the item compartment 215 can be configured in any suitable manner.

### 4.2 Sensor.

Embodiments of the system 200 can include one or more sensors 220 (e.g., a sensor set 220), which can function to sample sensor data for use in performing portions of embodiments of the method 100 (e.g., detection of item placement into an item compartment 215; item identification; smart shopping apparatus location and/or user location determination; check-out process implementation; security process implementation; etc.). Sensors 220 are preferably included in the smart shopping apparatus 210 (e.g., mounted to the item compartment 215 and/or other suitable physical region of the smart shopping apparatus 210), but can additionally or alternatively include sensors 220 associated with a user device (e.g., mobile computing device sensors 220, etc.), a merchant (e.g., sensors 220 of the merchant store, etc.), docking stations 250 (e.g., docking station sensors 220, etc.) and/or other suitable entities. The sensors 220 can include any one or more of optical sensors 222 (e.g., cameras; barcode scanners 221 for determining barcode scan data; barcode scanners 221 such as image-based barcode scanners, LED-based barcode scanners, laser-based barcode scanners, etc.), weight sensors 224 (e.g., weighing scale, etc.), audio sensors, temperature sensors, location sensors 225 (e.g., UWB-based sensors, beacons, GPS systems, etc.), proximity sensors 223 (e.g., electromagnetic sensors, capacitive sensors, ultrasonic sensors, light detection and ranging, light amplification for detection and ranging, line laser scanner, laser detection and ranging, etc.), virtual reality-related sensors, augmented reality-related sensors, volatile compound sensors, humidity sensors, depth sensors, inertial sensors, biometric sensors, pressure sensors, flow sensors, power sensors, and/or any other suitable types of sensors 220.

In an example, the sensor set 220 can include a barcode scanner 221 for determining barcode data for a barcode of the item (and/or for determining any suitable item identifiers); and an optical sensor for capturing one or more images of the item (e.g., after the placement of the item into the item compartment 215; in response to detecting placement of the item into the item compartment 215; etc.), such as where the shopping apparatus processing system 228 can be configured to facilitate the identification of the item profile for the item based on the barcode data and the one or more images of the item.

In an example, the smart shopping apparatus 210 can include two optical sensors 222′, 222″ (e.g., two cameras; optical sensors 222 positioned proximal an opening of the item compartment 215; optical sensors 222′, 222″ at opposite faces of the item compartment 215, with field of views that include the other optical sensor; etc.), a weight sensor 224 (e.g., a scale integrated with the bottom of the item compartment 215, for weighing items placed into the item compartment 215, etc.), and a location sensor 225 (e.g., based on UWB technology; based on beacon technology; for tracking location of the smart shopping apparatus 210 and/or user in relation to the merchant store; etc.). In a specific example, the smart shopping apparatus 210 can include a sensor set 220 including a first optical sensor 222′ (e.g., for capturing a first image of the item after placement of the item into the item compartment 215, etc.) positioned at a first interior surface of a first face of the item compartment 215; a second optical sensor 222″ (e.g., for capturing a second image of the item after the placement of the item into the item compartment 215, etc.) positioned at a second interior surface of a second face opposing the first face of the item compartment 215; and where the shopping apparatus processing system 228 can be configured to facilitate the identification of the item profile for the item based on the first image of the item and the second image of the item (and/or any other suitable data such as barcode data, such as where the images of the item can be used to verify the item placed into the item compartment 215 correctly corresponds to the item profile identified based on the barcode data).

In an example, the smart shopping apparatus 210 can include a set of directional sensors (e.g., directional optical sensors 222; directional motion sensors; directional proximity sensors; etc.), such as configured for performing any suitable portions of embodiments of the method 100. In a specific example, the smart shopping apparatus 210 can include a proximity sensor for sensing the proximity of the item during the placement of the item into the item compartment 215, where the proximity sensor can be positioned proximal the opening of the item compartment 215, where collected sensor data can include proximity sensor data, and where the shopping apparatus processing system 228 can be configured to detect the placement of the item into the item compartment 215 based on the proximity sensor data.

In an example, the smart shopping apparatus 210 can include a weight sensor 224 for determining a weight of an item (e.g., an item placed into the smart shopping apparatus 210, etc.), where the weight sensor 224 is positioned at a base of the item compartment 215 (e.g., a base connected to side faces of the item compartment 215; as shown in FIG. 4; etc.), and where the shopping apparatus processing system 228 can be configured to facilitate the identification of the item profile for the item based on the weight of the item (and/or other suitable data such as barcode data, images of the item, such as where the weight of the item can be used to verify the item placed into the item compartment 215 correctly corresponds to the item profile identified based on the barcode data).

Additionally or alternatively, the smart shopping apparatus 210 can include any suitable number and type of sensors 220 arranged at any suitable region of the smart shopping apparatus 210 (e.g., any suitable face of the item compartment 215; arranged at any suitable angle and directionality relative other components of the smart shopping apparatus 210; etc.). In specific examples, the smart shopping apparatus 210 can include any suitable combination of any number and type of sensors 220 described herein.

In variations, one or more sensors 220 can be integrated with (e.g., mounted to; positioned within; integrated with a face of; etc.) one or more housings, such as for providing protection to the one or more sensors 220 (e.g., protecting integrity of optical sensors 222, while not obstructing the field of view of the optical sensors 222; etc.), for facilitating physical connections between sensors 220 and other components (e.g., housing of physical wiring connections between sensors 220 and the shopping apparatus processing system 228; etc.), for providing thermal regulation (e.g., using housings with cooling features for reducing temperature proximal the sensor 220), for providing user protection (e.g., from injury associated with sensors 220 and/or other components; etc.), and/or for any suitable purposes. In an example, the one or more housings can be integrated with the one or more item compartments 215 (e.g., mounted at an interior surface of an item compartment 215, such as for facilitating orientation of optical sensors 222 to enable a field of view capturing item placement in relation to the item compartment 215; mounted at a handle of the item compartment 215, such as at a handle of an item compartment 215 of a smart shopping cart; etc.). Additionally or alternatively, housings can be used in relation to any suitable component (e.g., housings for any suitable components of a smart shopping apparatus 210; etc.). However, housings can be configured in any suitable manner with any suitable relationship with other components.

However, the sensors 220 can be configured in any suitable manner.

### 4.3 Shopping Apparatus Processing System.

Embodiments of the system 200 can include one or more shopping apparatus processing systems 228, which can function to control operations of components of the smart shopping apparatus 210 and/or perform any suitable portions of embodiments of the method 100 (e.g., detection of placement of items into the item compartment 215; item identification; facilitating a check-out process and/or a security process; etc.). In variations, the shopping apparatus processing system 228 can perform and/or be configured to at least one or more of receive sensor data (e.g., first sensor data corresponding to a first sensor, such as first sensor data describing placement of an item into an item compartment 215; second sensor data corresponding to a second sensor, such as second sensor data describing an item identifier of the item; etc.); detect the placement of the item into the item compartment 215 based on sensor data (e.g., first sensor data); facilitate identification of an item profile for the item based on sensor data (e.g., first sensor data and/or second sensor data, etc.); determine a shopping parameter associated with the shopping period, based on the item profile for the item; facilitate a purchase transaction (e.g., based on the item profile for the item; etc.); apply security processes; and/or perform any suitable portions of embodiments of the method 100.

In an example, facilitation, by the shopping apparatus processing system 228, of the identification of the item profile can include transmitting sensor data (e.g., raw sensor data; processed sensor data; the barcode data for a barcode of the item; one or more images of the item; the weight of the item; and/or any suitable sensor data) and/or any suitable data to a remote computing system 245 associated with the smart shopping apparatus 210 (e.g., through a WiFi communications module of the smart shopping apparatus 210; etc.). In a specific example, as shown in FIG. 5, an item profile can include a reference barcode value (e.g., a UPC number of a reference item described by the item profile; etc.), a reference image (e.g., of a reference item corresponding to the item profile), and a reference weight (e.g., corresponding to the reference item described by the item profile; etc.), where the remote computing system 245 (and/or shopping apparatus processing system 228) can identify the item profile for the item based on a comparison between the barcode data (e.g., collected barcode data from a barcode scanner 221 and/or other sensor, etc.), the reference barcode value, one or more images of the item (e.g., captured by an optical sensor 222 of the smart shopping apparatus 210; etc.), the reference image, the weight of the item (e.g., measured by a weight sensor 224 of the smart shopping apparatus 210; etc.), and the reference weight.

The shopping apparatus processing system 228 is preferably connected to (e.g., electrically connected to; in communication with; etc.) the sensors 220, the communication system 230, the user interface 235, and the power systems of embodiments of the smart shopping apparatus 210, but can additionally or alternatively be connected to any suitable components of the system 200. However, the shopping apparatus processing system 228 can be configured in any suitable manner.

### 4.4 Communication System.

Embodiments of the system 200 can include one or more communication systems 230, which can function to facilitate communication between the smart shopping apparatus 210 and/other entities (e.g., user devices, remote computing system 245s, remote merchant processing systems, point of sale systems 255, docking stations 250, merchant systems such as merchant displays, etc.), between components of the smart shopping apparatus 210, and/or between any other suitable components. The communication systems 230 can include any one or more of wireless communication systems (e.g., for facilitating WiFi, Bluetooth, radiofrequency, Zigbee, Z-wave, etc.), wired communication systems, and/or any other suitable type of communication systems 230. However, the communication system 230 can be configured in any suitable manner.

### 4.5 User Interface.

Embodiments of the system 200 can include one or more user interfaces 235, which can function to collect user inputs, present information (e.g., shopping parameters such as shopping lists, price data, item data, advertisements; smart shopping apparatus parameters such as battery life; check-out process information; security information, etc.) to a user, and/or otherwise act as an interface between the user and the smart shopping apparatus 210. The user interface 235 can include a display (e.g., graphical display, virtual reality display, augmented reality display, etc.), physical input components (e.g., a touchscreen, mechanical input components such as buttons, card readers, payment mechanisms, etc.), output components (e.g., speakers 246 for audio output, haptic feedback components, braille output components, etc.), and/or any other suitable components. However, the user interface 235 can be configured in any suitable manner.

### 4.6 Mechanical Components.

Embodiments of the system 200 can include one or more wheels 244, lids 242 (e.g., spring-based lids, etc.), and/or other suitable mechanical components 240 of a smart shopping apparatus 210, which can function to facilitate maneuverability (e.g., for enabling the user to move the smart shopping apparatus 210), security (e.g., a rollover lid that can cover an opening of the item compartment 215, in order to hinder item collection by a user from the smart shopping apparatus 210; wheel disablement mechanisms for hindering a user from moving a smart shopping apparatus 210, such as for use when a user has not successfully completed the check-out process; etc.), and/or other suitable functionality.

In an example, the system 200 can include a virtually defined exit bay area with an exit bay location proximal a merchant store corresponding to the shopping period, where a sensor set 220 of the smart shopping apparatus 210 can include a location sensor 225 for collecting location data describing the location of the smart shopping apparatus 210, and where the shopping apparatus processing system 228 can be configured to transform one or more mechanical components 240 of the smart shopping apparatus 210 based on the location data satisfying a threshold condition associated with the exit bay location (e.g., when the location of the smart shopping apparatus 210 exceeds a threshold distance from the exit bay location, such as when a user move a smart shopping apparatus 210 away from a merchant store without successfully completing a purchase transaction, etc.). In a specific example, the mechanical component 240 of the smart shopping apparatus 210 can include a set of wheels 244 for facilitating maneuverability of the smart shopping apparatus 210, and where the transformation of the mechanical component 240 can include locking at least one wheel of the set of wheels 244 based on failure to verify completion of a purchase transaction for the item and based on the location of the smart shopping apparatus 210 exceeding a threshold distance from the exit bay location of the virtually defined exit bay area. In a specific example, the mechanical component 240 of the smart shopping apparatus 210 can include a closable lid 242 for covering the opening of the item compartment 215, and where the transformation of the mechanical component 240 can include closing the lid 242 of the smart shopping apparatus 210 based on failure to verify completion of a purchase transaction for the item and based on detection of the location of the smart shopping apparatus 210 within the virtually defined exit bay area. Additionally or alternatively, any suitable security process can be applied for one or more mechanical components 240 and/or suitable components of embodiments of the system 200.

However, geographically defined areas, wheels 244, lids 242, speakers 246, mechanical components 240, and/or transformation of mechanical components 240 can be configured in any suitable manner.

### 4.7 Remote Computing System.

Additionally or alternatively, embodiments of the system 200 can include one or more remote computing systems 245 (e.g., including one or more databases, cloud computing components, etc.), which can function to facilitate processing operations associated with the method 100 (e.g., item identification, inventory management, data storage, shopping parameter determination, etc.).

The remote computing system 245 preferably includes one or more databases including one or item databases storing item profiles. In an example, the remote computing system 245 can include an item database storing searchable item profiles including reference item identifiers (e.g., known item identifiers, etc.) against which detected item identifiers (e.g., detected based on sensor data collected for items placed in relation to the smart shopping apparatus 210; etc.) can be compared (e.g., for mapping items associated with the smart shopping apparatus 210 to one or more item profiles stored in the item database; etc.). Additionally or alternatively, databases can store any suitable data described herein and can facilitate any suitable functionality of embodiments of the system 200 and any suitable portions of embodiments of the method 100. In variations, any suitable components can include databases. For example, smart shopping apparatuses 210 and/or docking stations 250 can include item databases, user databases (e.g., storing user data such as user account information and/or user preferences; etc.), and/or other suitable databases. However, databases and/or the remote computing system 245 can be configured in any suitable manner.

### 4.8 Docking Station.

Additionally or alternatively, embodiments of the system 200 can include one or more docking stations 250, which can function to charge one or more smart shopping apparatuses 210 (e.g., wired charging; wireless charging; where smart shopping apparatuses 210 can enter a docking station 250 automatically, such as in response to a user completing a shopping period with the smart shopping apparatus 210, in response to a threshold amount of idle time; where users can park smart shopping apparatuses 210 at a docking station 250; etc.), facilitate software updates (e.g., for updating the firmware and/or software of the smart shopping apparatuses 210, etc.), communicate with remote computing systems 245, perform smart shopping apparatus fleet management, and/or perform any other suitable functionality. However, docking stations 250 can be configured in any suitable manner.

Although omitted for conciseness, the embodiments include every combination and permutation of the various system components and the various method processes, including any variations, examples, and specific examples, where the method processes can be performed in any suitable order, sequentially or concurrently using any suitable system components. Any of the variants described herein (e.g., embodiments, variations, examples, specific examples, illustrations, etc.) and/or any portion of the variants described herein can be additionally or alternatively combined, excluded, and/or otherwise applied.

The system and method and embodiments thereof can be embodied and/or implemented at least in part as a machine configured to receive a computer-readable medium storing computer-readable instructions. The instructions are preferably executed by computer-executable components preferably integrated with the system. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the embodiments without departing from the scope defined in the following claims.

We claim:

1. A system for improving a shopping period for a user in relation to an item, the system comprising:
a smart shopping apparatus comprising:
an item compartment sized to hold the item, the item compartment comprising an opening for placement of the item into the item compartment;
a sensor set coupled to the item compartment, the sensor set comprising:
a first sensor for collecting first sensor data describing the placement of the item into the item compartment; and
a second sensor for collecting second sensor data describing an item identifier of the item;
a shopping apparatus processing system configured to:
receive the first sensor data;
receive the second sensor data;
detect the placement of the item into the item compartment based on the first sensor data;
facilitate identification of an item profile for the item based on the second sensor data; and
determine a shopping parameter associated with the shopping period, based on the item profile for the item.

2. The system of claim 1,
wherein the second sensor comprises a barcode scanner for determining barcode data for a barcode of the item, wherein the item identifier comprises the barcode data;
wherein the sensor set comprises a first optical sensor for capturing a first image of the item after the placement of the item into the item compartment; and
wherein the shopping apparatus processing system is configured to facilitate the identification of the item profile for the item based on the barcode data and the first image of the item.

3. The system of claim 2,
wherein the first optical sensor is positioned at a first interior surface of a first face of the item compartment,
wherein the sensor set comprises a second optical sensor for capturing a second image of the item after the placement of the item into the item compartment, wherein the second optical sensor is positioned at a second interior surface of a second face opposing the first face of the item compartment, and
wherein the shopping apparatus processing system is configured to facilitate the identification of the item profile for the item based on the barcode data, the first image of the item, and the second image of the item.

4. The system of claim 2, wherein the first sensor comprises a proximity sensor for sensing the proximity of the item during the placement of the item into the item compartment, wherein the proximity sensor is positioned proximal the opening of the item compartment, wherein the first sensor data comprises proximity sensor data, and wherein the shopping apparatus processing system is configured to detect the placement of the item into the item compartment based on the proximity sensor data.

5. The system of claim 2, wherein the sensor set comprises a weight sensor for determining a weight of the item, wherein the weight sensor is positioned at a base of the item compartment, and wherein the shopping apparatus processing system is configured to facilitate the identification of the item profile for the item based on the barcode data, the first image of the item, and the weight of the item.

6. The system of claim 5,
wherein the facilitation, by the shopping apparatus processing system, of the identification of the item profile comprises transmitting the barcode data, the first image of the item, and the weight of the item to a remote computing system associated with the smart shopping apparatus;
wherein the item profile comprises a reference barcode value, a reference image, and a reference weight corresponding to a reference item described by the item profile; and
wherein the system comprises the remote computing system configured to identify the item profile for the item based on a comparison between the barcode data, the reference barcode value, the first image of the item, the reference image, the weight of the item, and the reference weight.

7. The system of claim 1, further comprising a virtually defined exit bay area with an exit bay location proximal a merchant store corresponding to the shopping period, wherein the sensor set comprises a location sensor for collecting location data describing the location of the smart shopping apparatus, and wherein the shopping apparatus processing system is configured to transform a mechanical component of the smart shopping apparatus based on the location data satisfying a threshold condition associated with the exit bay location.

8. The system of claim 7, wherein the mechanical component of the smart shopping apparatus comprises a set of wheels for facilitating maneuverability of the smart shopping apparatus, and wherein the transformation of the mechanical component comprises locking at least one wheel of the set of wheels based on failure to verify completion of a purchase transaction for the item and based on the location of the smart shopping apparatus exceeding a threshold distance from the exit bay location of the virtually defined exit bay area.

9. The system of claim 7, wherein the mechanical component of the smart shopping apparatus comprises a closable lid for covering the opening of the item compartment, and wherein the transformation of the mechanical component comprises closing the lid of the smart shopping apparatus based on failure to verify completion of a purchase transaction for the item and based on detection of the location of the smart shopping apparatus within the virtually defined exit bay area.

10. The system of claim 1, wherein the smart shopping apparatus comprises at least one of a smart shopping cart, a smart shopping basket, and a smart shopping bag.

11. A method for applying a smart shopping apparatus to improve a shopping period for a user in relation to an item, the method comprising:
detecting the placement of the item into the smart shopping apparatus based on first sensor data;
collecting second sensor data describing an item identifier of the item;
identifying an item profile for the item based on the second sensor data;
determining a shopping parameter associated with the shopping period based on the item profile; and
facilitating a purchase transaction for the item based on the shopping parameter.

12. The method of claim 11, further comprising transforming a mechanical component of the smart shopping apparatus based on verification of the purchase transaction, wherein the mechanical component comprises at least one of a set of wheels, a lid for an item compartment of the smart shopping apparatus, and a speaker.

13. The method of claim 12, wherein transforming the mechanical component comprises disabling a security process associated with the mechanical component based on the verification of the purchase transaction, wherein disabling the security process comprises at least one of unlocking at least one wheel of the set of wheels, opening the lid for the item compartment of the smart shopping apparatus, and emitting, with the speaker, audio associated with the verification of the purchase transaction.

14. The method of claim 11,
wherein collecting the second sensor data comprises collecting image data for the item with an optical sensor of the smart shopping apparatus,
wherein identifying the item profile comprises, in response to successfully detecting a barcode attached to the item based on the image data:
extracting a barcode value for the item based on the image data;
mapping the barcode value to a reference barcode value from the item profile; and
identifying the item profile based on the mapping.

15. The method of claim 14, wherein identifying the item profile comprises, in response to failing to detect the barcode attached to the item based on the image data:
determining a first comparison between a reference weight from the item profile and an item weight measured by a weight sensor of the smart shopping apparatus;
determining a second comparison between a reference image from the item profile and the image data; and
identifying the item profile for the item based on the first comparison and the second comparison.

16. The method of claim 11,
wherein detecting the placement of the item into the smart shopping apparatus comprises detecting the placement of the item into the smart shopping apparatus by a merchant entity distinct from the user, based on the first sensor data;
wherein the purchase transaction comprises a remote purchase transaction completed by the user;
wherein the shopping parameter describes fulfillment of the remote purchase transaction; and
wherein facilitating the remote purchase transaction comprises, in response to determining the shopping parameter, transmitting the shopping parameter to a user device associated with the user.

17. The method of claim 11,
wherein facilitating the purchase transaction comprises facilitating, with a point of sale system of the smart shopping apparatus, the purchase transaction for the user at a shopping area of a merchant store associated with the shopping period,
wherein the shopping area is distinct from a checkout area of the merchant store, and
wherein the method further comprises in response to verification of the purchase transaction, applying a security process with the smart shopping apparatus to hinder placement of additional items into the smart shopping apparatus.

18. The method of claim 1, wherein identifying the item profile item comprises identifying the item profile for the item based on the first sensor data and the second sensor data.

19. The method of claim 11, further comprising:
prior to detecting the placement of the item into the smart shopping apparatus:
collecting first location sensor data from a location sensor of the smart shopping apparatus, the first location sensor data describing the location of the smart shopping apparatus; and
guiding the user through a merchant store to an item location of the item based on the first location sensor data; and
in response to determining the shopping parameter:
collecting second location sensor data from the location sensor; and
guiding the user through the merchant store to an additional item location of an additional item based on the second location sensor data.

20. The method of claim 11,
wherein detecting the placement of the item into the smart shopping apparatus comprises detecting the placement of the item into the smart shopping apparatus based on the first sensor data and a placement detection model, and
wherein identifying the item profile for the item comprises identifying the item profile for the item based on the second sensor data and an item profile model.
